(19) United States
(12) Patent Application Publication
(10) Pub. No.: US 2025/0117896 A1
(43) Pub. Date: Apr. 10, 2025

(54) NOISE REDUCTION PROCESSING METHOD AND NOISE REDUCTION PROCESSING APPARATUS

(71) Applicant: SHIMADZU CORPORATION, Kyoto-shi (JP)

(72) Inventor: Tetsuya KOBAYASHI, Kyoto-shi (JP)

(21) Appl. No.: 18/907,049

(22) Filed: Oct. 4, 2024

(30) Foreign Application Priority Data
Oct. 6, 2023 (JP) 2023-174674

(51) Int. Cl. G06T 5/70; G06T 5/20; G06T 7/00

(52) U.S. Cl. CPC G06T 5/70; G06T 5/20; G06T 7/0002; G06T 2207/20028

(57) ABSTRACT

A noise reduction processing method according to this invention includes a step of acquiring a low-frequency signal by applying a first filter including a first filter window to a target signal, a step of estimating a noise signal by applying a second filter window including a second filter window independent of the first filter window to a high-frequency signal acquired based on the target signal and the low-frequency signal, and a step of acquiring a low-noise signal.

### CROSS-REFERENCE TO RELATED APPLICATIONS

The related application number JP2023-174674, noise reduction processing method and noise reduction processing apparatus, Oct. 6, 2023, KOBAYASHI Tetsuya, upon which this patent application is based are hereby incorporated by reference.

### BACKGROUND OF THE INVENTION

### Field of the Invention

The present invention relates to a noise reduction processing method and a noise reduction processing apparatus, in particular to a noise reduction processing method and a noise reduction processing apparatus for reducing noise while keeping a high-frequency component of a target signal.

### Description of the Background Art

Noise reduction processing methods for reducing noise while preserving a high-frequency component of a target signal are known in the art. For example, such a noise reduction processing method is disclosed in Dutta, Joyita, Richard M. Leahy, and Quanzheng Li., “Non-local means denoising of dynamic PET images.”, PLOS ONE, 8.12 (2013), e81390 (Hereinafter, “Non-Patent Document 1”).

The above non-patent document 1 discloses noise reduction processing for suppressing reduction of noise reduction effect caused by positional dependency of noise in an image by using an edge-preserving smoothing filter. Specifically, the aforementioned non-patent document 1 discloses a technique for performing Non-local means filtering, which is the edge-preserving smoothing filter for acquiring, by performing template matching between pixels in the support window set for a neighborhood area near a given pixel and pixels in a template window, similarity between the pixels in the support window the pixels in the template window and performing weighting filtering in accordance with the similarity. Also, in a configuration disclosed in the above non-patent document 1, noise included in the image is estimated, and filter coefficients used for filtering are acquired. Also, the above non-patent document 1 discloses noise reduction processing for suppressing reduction of noise reduction effect based on the positional dependency of noise by calculating a standard deviation in the neighborhood area for each pixel as an estimation value of the pixel and using the estimation value.

The present inventors have diligently studied the noise reduction processing, and as a result have found that a high-frequency component of a target is impaired in a case in which a standard deviation in the neighborhood area is calculated for each pixel to estimate noise for each pixel as in the above non-patent document 1.

### SUMMARY OF THE INVENTION

The present invention is intended to solve the above problem, and one object of the present invention is to provide a noise reduction processing method capable of reducing noise while suppressing impairment of a high-frequency component of a target.

The present inventors have found that impairment of a high-frequency component of a filtering target can be suppressed by making size of a filter window used in extraction of a low-frequency component different from size of a filter window used in estimation of a noise component from a high-frequency component, which includes an original signal and the noise component, (difference between the original signal and the extracted low-frequency component) independently of each other. Also, to improve accuracy of noise estimation, it can be conceived that the size of the filter window used in extraction of the noise component from the high-frequency component is set large.

A noise reduction processing method according to a first aspect of the present invention is a method for reducing noise in a target signal including a step of estimating a noise signal representing an intensity distribution of the noise in the target signal based on the target signal; a step of calculating a similarity index between a predetermined signal that is acquired at a first signal point and a signal that is acquired at a second signal point in proximity to the first signal point based on the target signal and the noise signal; a step of calculating a filter coefficient of a noise reduction filter based on the similarity index; a step of acquiring a low-noise signal by applying the noise reduction filter to the target signal based on the filter coefficient, wherein in the step of estimating the noise signal, a low-frequency signal is acquired by applying a first filter including a first filter window to the target signal, a high-frequency signal is acquired based on the target signal and the low-frequency signal, and the noise signal is estimated by applying a second filter including a second filter window independent of the first filter window to the high-frequency signal. Here, the second filter window independent of the first filter window refers to a second filter window whose size can be set independently of the size of the first filter window.

A noise reduction processing apparatus according to a second aspect of the present invention is an apparatus for reducing noise in a target signal including a target signal acquirer for acquiring the target signal; and a noise reducer for reducing noise in the target signal, wherein the noise reducer is configured to acquire a low-frequency signal by applying a first filter including a first filter window to the target signal, to acquire a high-frequency signal based on the target signal and the low-frequency signal and to estimate the noise signal by applying a second filter including a second filter window independent of the first filter window to the high-frequency signal, to calculate a similarity index between a predetermined signal that is acquired at a first signal point and a signal that is acquired at a second signal point in proximity to the first signal point based on the target signal and the noise signal, to calculate a filter coefficient of a noise reduction filter based on the similarity index, and to acquire a low-noise signal by applying the noise reduction filter to the target signal based on the filter coefficient.

Also, a noise reduction processing method according to a third aspect of the present invention is a method for reducing noise in a target signal including a step of estimating a noise signal representing an intensity distribution of the noise in the target signal based on the target signal; a step of calculating a similarity index between a predetermined signal that is acquired at a first signal point and a signal that is acquired at a second signal point in proximity to the first signal point based on the target signal and the noise signal; a step of calculating a filter coefficient of a noise reduction filter based on the similarity index; a step of acquiring a low-noise signal by applying the noise reduction filter to the target signal based on the filter coefficient; and a step of acquiring a low-noise composite signal by combining the target signal and the low-noise signal for adjustment of noise reduction effect.

A noise reduction processing apparatus according to a fourth aspect of the present invention is an apparatus for reducing noise in a target signal including a target signal acquirer for acquiring the target signal; and a noise reducer for reducing noise in the target signal, wherein the noise reducer is configured to estimate a noise signal representing an intensity distribution of the noise in the target signal based on the target signal, to calculate a similarity index between a predetermined signal that is acquired at a first signal point and a signal that is acquired at a second signal point in proximity to the first signal point based on the target signal and the noise signal, to calculate a filter coefficient of a noise reduction filter based on the similarity index, to acquire a low-noise signal by applying the noise reduction filter to the target signal based on the filter coefficient, and to acquire a low-noise composite signal by combining the target signal and the low-noise signal for adjustment of noise reduction effect.

In the noise reduction processing method according to the first aspect and the noise reduction processing apparatus according to the second aspect of the present invention, the noise signal is estimated by applying a second filter including a second filter window independent of the first filter window of the first filter, which is used in acquisition of the low-frequency signal, to the high-frequency signal. Accordingly, because size of the first filter window and size of the second filter window can be set independently of each other, it is possible to suppress impairment of the high-frequency component of the target. Also, the noise signal is estimated by applying a second filter including a second filter window independent of the first filter window, which is used in acquisition of the low-frequency signal, to the high-frequency signal. Accordingly, the noise signal can be estimated by setting the size of the first filter window and the size of the second filter window depending on the target signal. For this reason, because a statistical variation of noise levels in the noise signal estimated can be suppressed by changing the size of the second filter window depending on the target signal, it is possible to improve estimation accuracy of the noise signal. Consequently, it is possible to improve accuracy of the similarity index acquired based on the noise signal. In addition, because the accuracy of the similarity index can be improved, it is possible to accurately calculate the filter coefficient. Therefore, it is possible to reduce noise while suppressing impairment of the high-frequency component of the target.

Also, in the noise reduction processing method according to the third aspect and the noise reduction processing apparatus according to the fourth aspect of the present invention, a low-noise composite signal is acquired by combining the target signal and the low-noise signal for adjustment of noise reduction effect.

Accordingly, the combination of the target signal and the low noise signal can achieve both suppression of impairment of the high-frequency component of the target signal due to the target signal, and noise reduction using the low-noise signal. As a result, it is possible to provide a noise reduction processing method and a noise reduction processing apparatus capable of reducing noise while suppressing impairment of a high-frequency component of a target. Also, in the noise reduction processing method according to the third aspect and the noise reduction processing apparatus according to the fourth aspect of the present invention, a low-noise composite signal is acquired by combining the target signal and the low-noise signal for adjustment of noise reduction effect. Accordingly, the noise reduction effect can be easily adjusted by adjusting a combination ratio between the target signal and the low-noise signal. Consequently, it is possible to reduce time required for adjustment of the noise reduction effect as compared with a configuration in which parameters are changed and a series of processes for acquiring a low-noise signal from a target signal is executed again.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a block diagram showing a configuration of a noise reduction processing apparatus according to one embodiment.

FIG. 2 is a table for illustrating exemplary target signals.

FIG. 3 is a table for illustrating exemplary auxiliary signals.

FIG. 4 is a block diagram for illustrating a configuration in which the noise reduction processing apparatus according to the one embodiment reduces noise of a target signal.

FIG. 5 is a block diagram for illustrating a configuration in which the noise reduction processing apparatus according to the one embodiment estimates a noise signal.

FIG. 6 is a schematic diagram/graph for illustrating a model of noise distribution.

FIG. 7 is a block diagram for illustrating a configuration in which a combination processor according to the one embodiment acquires a low-noise composite signal.

FIG. 8 is a flowchart for illustrating noise reduction processing in a noise reduction processing method according to the one embodiment.

FIG. 9 is an exemplary image for illustrating an original image used in one example.

FIG. 10 is an exemplary image for illustrating the original image with noise added according to the one example.

FIG. 11 is an exemplary image for illustrating a low-noise image in a first comparative example.

FIG. 12 is an exemplary image for illustrating an edge comparison image, which is an image for comparing edges between the low-noise image in the first comparative example and the original image.

FIG. 13 is an exemplary image for illustrating a low-noise image in a second comparative example.

FIG. 14 is an exemplary image for illustrating an edge comparison image, which is an image for comparing edges between the low-noise image in the second comparative example and the original image.

FIG. 15 is an exemplary image for illustrating a low-noise image in a first example.

FIG. 16 is an exemplary image for illustrating an edge comparison image, which is an image for comparing edges between the low-noise image in the first example and the original image.

FIG. 17 is an exemplary image for illustrating a low-noise image in a second example.

FIG. 18 is an exemplary image for illustrating an edge comparison image, which is an image for comparing edges between the low-noise image in the third example and the original image.

FIG. 19 is a flowchart for illustrating noise reduction processing in a noise reduction processing method according to a modified embodiment.

### DESCRIPTION OF THE PREFERRED EMBODIMENT

Embodiments embodying the present invention will be described with reference to the drawings.

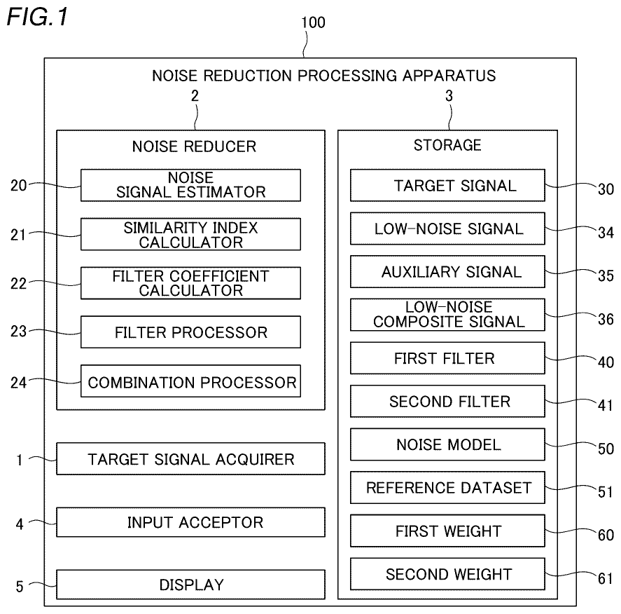

The following description will describe configurations of a noise reduction processing apparatus 100 and a noise reduction processing according to one embodiment with reference to FIGS. 1 to 7. The noise reduction processing apparatus 100 reduces noise of a target signal 30.

As shown in FIG. 1, the noise reduction processing apparatus 100 includes a target signal acquirer 1, a noise reducer 2, a storage 3, an input acceptor 4, and a display 5. The noise reduction processing apparatus 100 is realized by a computer.

The target signal acquirer 1 acquires a target signal 30. In this embodiment, the target signal acquirer 1 can acquire the target signal 30 acquired by various modalities such as X-ray imaging apparatus, CT (computed Tomography) apparatus, and PET (Positron Emission Tomography) apparatus. The target signal acquirer 1 is an input/output interface, for example. Also, for example, the target signal 30 is an X-ray image, a CT image, a PET image, or the like. The target signal 30 will be described later.

The noise reducer 2 is configured to reduce the noise in the target signal 30. The noise reducer 2 is constructed of a processor, such as a CPU (Central Processing Unit), GPU (Graphics Processing Unit) or an FPGA (Field-Programmable Gate Array), or circuitry, and a memory, such as a ROM (Read Only Memory) and a RAM (Random Access Memory).

The noise reducer 2 includes a noise signal estimator 20, a similarity index calculator 21, a filter coefficient calculator 22, a filter processor 23, and a combination processor 24 as function blocks. The functional parts 20 to 24 are constructed of software as the functional blocks realized by executing various programs stored in the storage 3 by the noise reducer 2. The functional parts 20 to 24 may be constructed of hardware by providing dedicated processors (processing circuits) separately from each other. The functional parts 20 to 24 will be described later.

The storage 3 stores the various programs to be executed by the noise reducer 2. In addition, the storage 3 stores the target signal 30, a low-noise signal 34 described later, an auxiliary signal 35 described later, a low-noise composite signal 36 described later, a first filter 40, a second filter 41, a noise model 50 described later, a reference dataset 51 described later, a first weight 60 described later, and a second weight 61 described later. The first filter 40 includes a smoothing filter. Also, the second filter 41 includes a standard deviation filter. The storage 3 includes a nonvolatile storage, such as an HDD (Hard Disk Drive) or an SSD (Solid State Drive), for example.

The input acceptor 4 accepts operating inputs from a user. The input acceptor 4 includes an input devices such as a keyboard and a computer mouse.

The display 5 displays at least one of the low-noise signal 34 and the low-noise composite signal 36. The display 5 is a display device, such as an LCD monitor or an organic EL (Electro Luminescence) monitor.

### (Target Signal)

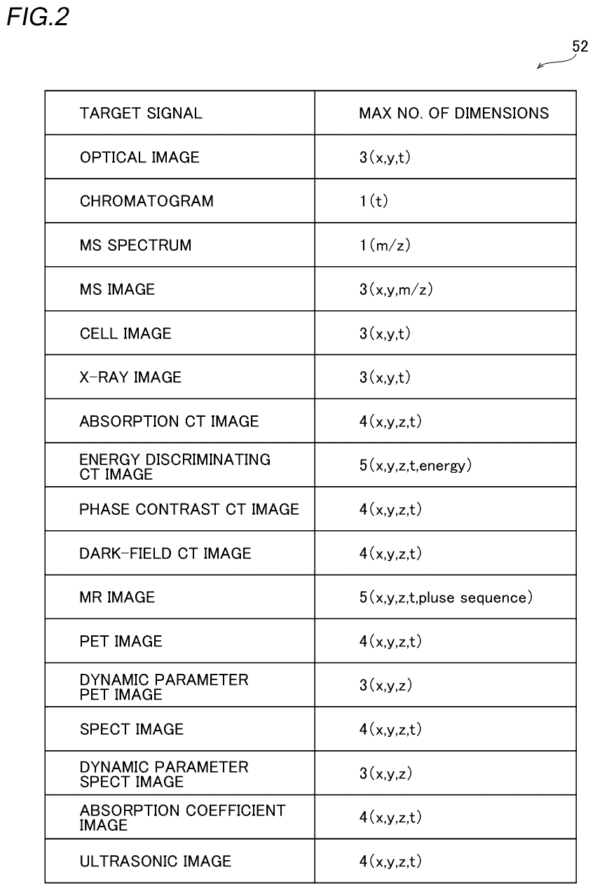

The target signal 30 (see FIG. 1) includes one- or higher-dimensional signal. Table 52 in FIG. 2 shows exemplary target signals 30, and the maximum numbers of dimensions of the target signals 30. As shown in Table 52, the target signal 30 includes an optical image (still image), an optical image (video), a chromatogram, MS (Mass Spectrometry) spectrum, an MS image, a cell image, an X-ray image (still image), an X-ray image (video), an absorption CT image, an energy discrimination CT image, a phase contrast CT image, dark field CT image, an MR (Magnetic Resonance) image, a PET images, a dynamic parameter PET image, a SPECT (Single Photon Emission computed Tomography) image, a dynamic parameter SPECT images, an absorption coefficient image, and an ultrasonic image. In this specification, the number of dimensions of a target signal refers to the number of coordinate axes required to specify a predetermined signal element included in the target signal.

The cell image is a static or video of a cell used to observe a shape, size, and an internal structure of a cell. The energy discrimination CT image is a CT image that is imaged using energy information of X-rays. The phase contrast CT images and dark field CT image is a CT image that is imaged using X-ray phase information. The dynamic parameter PET image is a PET image that is imaged based on physiological parameters (e.g., velocity constant of compartment model) obtained from radioactivity concentration time-series data (time-radioactivity curve). The dynamic parameter SPECT image is a SPECT image that is imaged based on physiological parameters obtained from radioactivity concentration time-series data. The absorption coefficient image is an image that is imaged based on absorption coefficients, and is used in PET and SPECT.

In the target signals 30 shown in Table 52, one-dimensional signals are the chromatogram and the MS spectrum; two-dimensional signals are a still image of the optical image, a still image of the X-ray image, and the cell image; three-dimensional signals are video of the optical image, the MS image, video of the X-ray image, video of the cell image, the dynamic parameter PET image, and the dynamic parameter SPECT image; four-dimensional signals are the absorption CT image, the phase contrast CT image, the dark field CT image, the PET image, the SPECT image, the absorption coefficient image, and the ultrasonic image; and five-dimensional signals are the energy discrimination CT image, and the MR image.

The optical image (still image), optical image (video), and the cell image may include noise such as high sensitivity noise caused by setting of sensitivity to high, block noise occurring in compression of the image, amplifier noise due to heat, and dark current noise due to a dark current. The chromatogram may include noise such as white noise and tailing. The MS spectrum may include noise such as white noise and Poisson noise. The MS image can may noise such as white noise and Poisson noise. The X-ray image (still image) and the X-ray image (video) may include noise such as quantum noise, noise caused by X-ray scattering, noise caused by defects of a detector, and dark current noise caused by a dark current. The absorption CT image, the energy discrimination CT image, the phase contrast CT image, and the dark field CT image may include noise such as quantum noise, noise caused by X-ray scattering, noise caused by defects of a detector, and dark current noise caused by a dark current. The MR image, the PET image, the dynamic parameter PET image, the SPECT image, the dynamic parameter SPECT image, and the absorption coefficient image may include noise such as quantum noise. The ultrasonic images may include noise caused by noises generated by components such as a power source and an amplifier.

If the target signal 30 includes such noise, accuracy of analysis, analyzing and diagnosis using the target signal 30 will decrease. To address this, the noise reduction processing apparatus 100 (see FIG. 1) reduce the noise in the target signal 30 to suppress the deterioration of the accuracy of analysis, analyzing and diagnosis using the target signal 30. In this embodiment, the following description describes a configuration for reducing noise in the target signal 30 that is a two- or higher-dimensional image signal.

### (Auxiliary Signal)

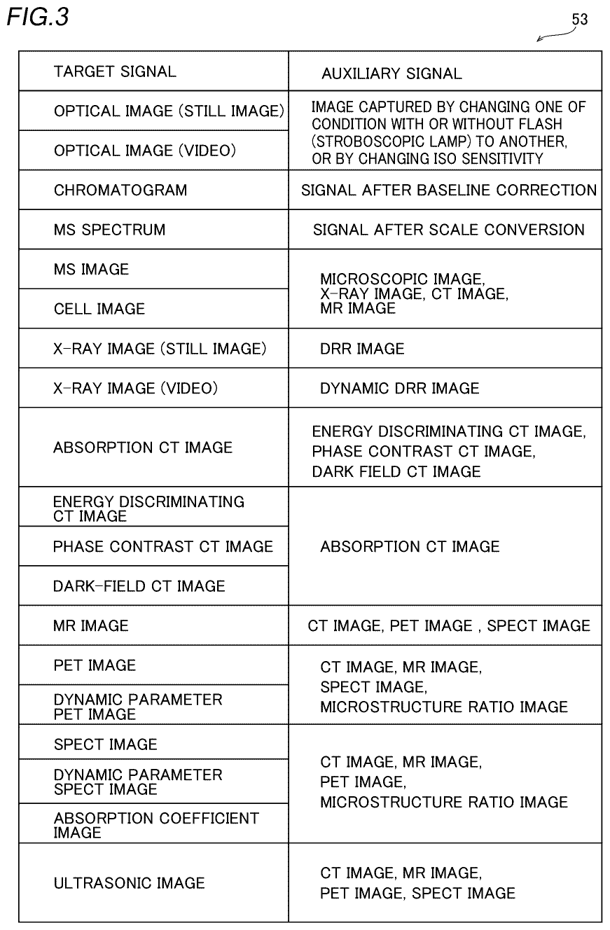

The auxiliary signal 35 used to reduce noise in the target signal 30 is now described with reference to FIG. 3. The auxiliary signal 35 is a signal of a common target whose target signal 30 has been acquired, but the auxiliary signal is acquired by an apparatus that is different from an apparatus that captures the target signal 30, under an acquisition condition that is different from a condition that the target signal 30 is acquired, or under a processing condition that is different from processing condition that the target signal 30 is acquired.

Table 53 shown in FIG. 3 shows the target signals 30 and the corresponding ones of auxiliary signal 35.

In a case in which the target signal 30 is the optical image (still image) or the optical image (video), the auxiliary signal 35 includes an image of the same scene that is captured by changing one of condition with or without a flash of light (stroboscopic lamp) to another, or by changing an ISO sensitivity.

In a case in which the target signal 30 is the chromatogram, the auxiliary signal 35 includes a signal after baseline correction. In a case in which the target signal 30 is the MS spectrum, the auxiliary signal 35 includes a signal after scale conversion. In a case in which the target signal 30 is the MS image or a cell image, the auxiliary signal 35 includes a microscopic image of the same sample, an X-ray image of the same sample, a CT image of the same sample, or an MR image of the same sample. In a case in which the target signal 30 is a signal of the X-ray image (still image), the auxiliary signal 35 includes a DRR (Digital Reconstructed Radiograph) image of the same subject. The DRR image is a two-dimensional image of a predetermined focal point reconstructed from a CT image. In a case in which the target signal 30 is a signal of the X-ray image (video), the auxiliary signal 35 includes a dynamic DRR image of the same subject. The dynamic DRR image is a moving DRR image including a plurality of DRR images. In a case in which the target signal 30 is an absorption CT image, the auxiliary signal 35 includes an energy discriminating CT image of the same subject, a phase contrast CT image of the same subject, or a dark field CT image of the same subject. In a case in which the target signal 30 is the energy discriminating CT image, the phase contrast CT image, or the dark-field CT image, the auxiliary signal 35 includes an absorption CT image of the same subject. In a case in which the target signal 30 is the MR image, the auxiliary signal 35 includes a CT image of the same subject, a PET image of the same subject, or a SPECT image of the same subject. In a case in which the target signal 30 is the PET image or the dynamic parameter PET image, the auxiliary signal 35 includes a CT image, an MR image, a SPECT image, or a microstructure ratio image. The microstructure ratio image is an image that is imaged based on composition ratios of substances included in each pixel of a subject. In a case in which the target signal 30 is the SPECT image, the dynamic parameter SPECT image, or the absorption coefficient image, the auxiliary signal 35 includes a CT image, an MR image, a PET image, or a microstructure ratio image. In a case in which the target signal 30 is the ultrasonic image, the auxiliary signal 35 includes a CT image, an MR image, a PET image, or a SPECT image.

In a case if a multi-modality imaging apparatus such as a PET-CT apparatus, PET-MR apparatus, an MS imaging apparatus capable of acquiring both MS and optical images at the same time, or a CT apparatus capable of acquiring absorption CT, phase contrast CT and dark-field CT images at the same time, the target signal 30 and the auxiliary signal 35 can be acquired at the same time. Even in a case of an apparatus other than the multi-modality imaging apparatus, the auxiliary signal 35 equivalent to the auxiliary signal acquired by the multi-modality imaging apparatus can be acquired by aligning positions of images of a common to-be-imaged object that are captured by different modalities, or applying other processing to the images.

The auxiliary signal 35 can be acquired by applying signal processing to the target signal 30. For example, the auxiliary signal 35 can be acquired by applying noise reduction processing, contrast enhancement processing, histogram flattening processing, edge enhancement processing, hard segmentation processing, soft segmentation processing, multiresolution decomposition processing, monochrome conversion processing, or the like to the target signal 30. Hard segmentation processing is processing for dividing an image into regions. The soft segmentation processing includes microstructure ratio estimation processing. The multiresolution decomposition processing includes a wavelet transform.

### (Noise Reduction Processing and Generation of Low-Noise Composite Signal)

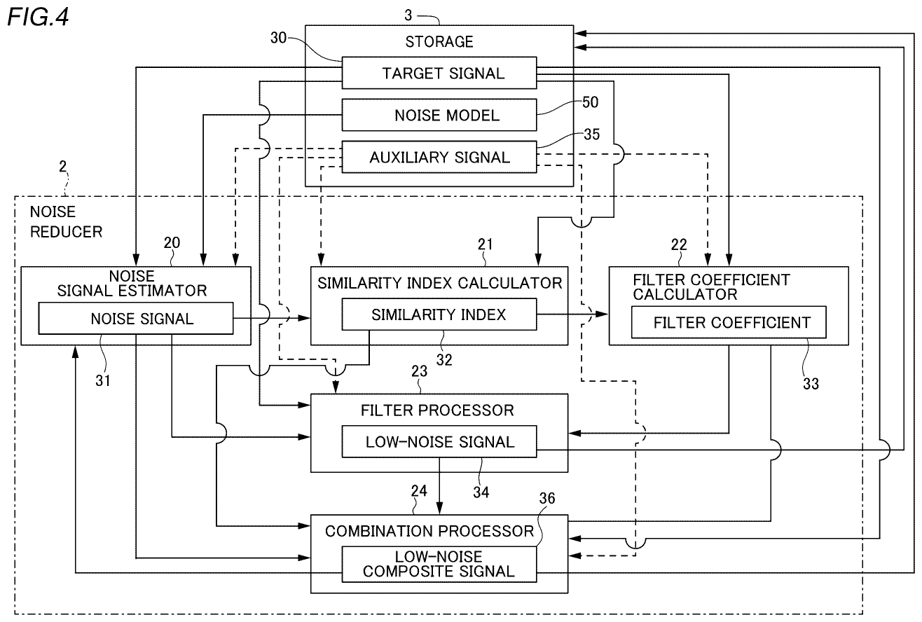

The following description describes a configuration in which the noise reducer 2 (see FIG. 4) reduces noise in the target signal 30 (see FIG. 4) with reference to FIGS. 4 to 7.

As shown in FIG. 4, the noise reducer 2 reduces the noise in the target signal 30 by estimating a noise signal 31, calculating a similarity index 32, calculating a filter coefficient 33, and acquiring a low-noise signal 34 and a low-noise composite signal 36. The following description specifically describes these processes.

### (Estimation of Noise Signal)

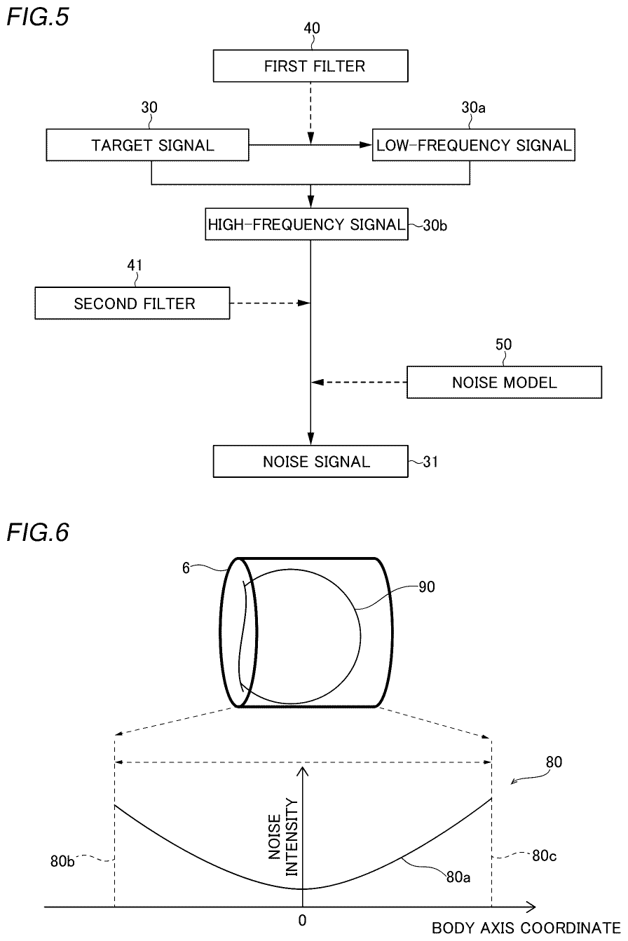

As shown in FIGS. 4 and 5, the noise signal estimator 20 acquires the target signal 30 from the storage 3, and estimates the noise signal 31 representing an intensity distribution of the noise in the target signal 30 based on the target signal 30. Specifically, the noise signal estimator 20 acquires a low-frequency signal 30a by applying the first filter 40 including a first filter window to the target signal 30. The noise signal estimator 20 acquires a high-frequency signal 30b based on the target signal 30 and the low-frequency signal 30a. Specifically, the noise signal estimator 20 acquires the high-frequency signal 30b by subtracting the low-frequency signal 30a from the target signal 30.

The noise signal estimator 20 estimates the noise signal 31 by applying the second filter 41 including a second filter window independent of the first filter window to the high-frequency signal 30b. The noise signal estimator 20 estimates the noise signal 31 by applying the standard deviation filter that is different from the smoothing filter to the high-frequency signal 30b. In this embodiment, the noise signal estimator 20 estimates the noise signal 31 by using the standard deviation filter including the second filter window larger than the first filter window of the smoothing filter. For example, the noise signal estimator 20 uses, as the smoothing filter, a smoothing filter such as a moving average filter, a Gaussian filter, a median filter, a weighted median filter, a bilateral filter, a non-local means filter, or a guided filter. The guided filter is a filter capable of reducing noise while preserving an edge (high-frequency signal 30b) by using an input image and a guidance image.

### (Model of Noise Distribution)

The target signal 30 includes noise caused by an acquisition principle in acquisition of the image signal (target signal 30) and noise caused by an apparatus that acquires the image signal. These types of noise have predetermined distributions depending on the acquisition principle and the apparatus. For example, intensities of the noise form a downward convex distribution as shown in FIG. 6 in some cases.

A graph 80 shown in FIG. 6 shows a distribution of noise caused by an acquisition principle in acquisition of a PET image. A vertical axis indicates a noise intensity, and a horizontal axis indicates a body axis coordinate in the graph 80.

In a case in which the PET image is acquired, a to-be-imaged object 90 is placed inside a cylindrical detector 6. In this case, detection sensitivity to radiation in a central part of the cylindrical detector 6 is high, and the sensitivity becomes lower toward ends of the detector 6. In other words, in the case in which the PET image is acquired, a noise intensity tends to be lower in the central part of the detector 6, and the noise intensity tends to become higher toward the ends of the detector 6.

A curve 80a shown in the graph 80 shows a distribution of noise. A dashed line 80b is a body axis coordinate corresponding to one end of the detector 6, and a dashed line 80c is a body axis coordinate corresponding to another end of the detector 6. The noise intensity becomes lower as the body axis coordinate approaches 0 (central part) as shown in the curve 80a.

For this reason, in this embodiment, the noise signal estimator 20 estimates the noise signal 31 by using the noise model 50, which is modeled based on a noise distribution of one of noise caused by the acquisition principle in acquisition of the image signal and noise caused by the apparatus that acquires the image signal.

For example, the noise model 50 can be represented by the following Equation (1).

$$\begin{matrix}[ Formula 1 ] & \\ {σ}^{prior} ( Z ) = a * {z}^{p} + b & ( 1 )\end{matrix}$$

where a, b and p are parameters. The noise model 50 can be acquired by obtaining the parameters corresponding to the noise distribution. The noise model 50 is previously acquired and stored in the storage 3 (see FIG. 4). Note that the noise model 50 may be acquired before the target signal 30 is acquired, or may be acquired after the target signal 30 is acquired as long as the noise model can be used when noise reduction processing is applied to the target signal 30.

With reference to FIG. 5 again, the noise model is described. The noise signal estimator 20 estimates the noise signal 31 by multiplying the high-frequency signal 30b by the noise model 50 after applying the second filter 41 to the high-frequency signal. Specifically, the noise signal estimator 20 estimates the noise signal 31 based on the following Equation (2). The noise model 50 includes a homogeneous noise model (a noise model that does not substantially change, even when a signal is multiplied by the noise model, its high-frequency signal 30b).

$$\begin{matrix}[ Formula 2 ] & \\ {σ}^{m} = {σ}^{prior} ⊗ σ & ( 2 )\end{matrix}$$

where σ^{m} is the noise signal 31 multiplied by the noise model 50, σ^{prior} is the noise model 50, and σ is the noise signal 31 before the noise signal is multiplied by the noise model 50. Here, an encircled cross symbol indicates a product for each pixel.

With reference to FIG. 4 again, the noise signal estimator is described. The noise signal estimator 20 may be configured to estimate the noise signal 31 by using the auxiliary signal 35. In this configuration, the noise signal estimator 20 acquires the auxiliary signal 35 from the storage 3. The noise signal estimator 20 acquires the high-frequency signal 30b (see FIG. 5) by using an edge-preserving smoothing filter that uses the auxiliary signal 35, such as Joint-Bilateral filter or Joint-Non local means filter.

The noise signal estimator 20 outputs the noise signal 31 estimated to the similarity index calculator 21.

### (Calculation of Similarity Index)

As shown in FIG. 4, the similarity index calculator 21 acquires the target signal 30 from the storage 3, and acquires the noise signal 31 from the noise signal estimator 20. The similarity index calculator 21 calculates the similarity index 32 between a predetermined signal that is acquired at a first signal point and a signal that is acquired at a second signal point in proximity to the first signal point based on the target signal 30 and the noise signal 31.

The similarity index 32 is an index based on the similarity between the signal that is acquired at the first signal point and the signal that is acquired at the second signal point. For example, the similarity index 32 includes a signal alienation degree index between any two pixels defined by the following Equation (3).

$$\begin{matrix}[ Formula 3 ] & \\ {Δ}_{1 jk} = max ( \frac{1}{\vert {τ}_{j} \vert} {‖ {t}_{j} - {t}_{k} ‖}_{2}^{2} - 2 {σ}_{j}^{2} , 0 ) & ( 3 )\end{matrix}$$

where Δᵢⱼₖ is the similarity index 32, σⱼ is a value of a pixel j of the noise signal 31 (image σ), Tⱼ is a circular template window that centers the pixel j, |Tⱼ| is the number of pixels included in Tⱼ, and tⱼ is a vector including of pixel values of the pixels included in Tⱼ (hereinafter referred to as a template vector). The template window may be a rectangular window.

The similarity index calculator 21 may be configured to calculate the similarity index 32 by using the following Equation (4) instead of the above Equation (3).

$$\begin{matrix}[ Formula 4 ] & \\ {Δ}_{1 jk} = \frac{1}{\vert {τ}_{j} \vert} {‖ {t}_{j} - {t}_{k} ‖}_{2}^{2} & ( 4 )\end{matrix}$$

For example, in a case in which the target signal 30 is a multi-channel image including a plurality of pixel values for each pixel, such as an RGB image, the similarity index calculator 21 may calculate the similarity index 32 by the following Equation (5) or (6).

$$\begin{matrix}[ Formula 5 ] & \\ {Δ}_{1 jk} = max ( \frac{1}{\vert {τ}_{j} \vert} {\sum }_{k ∈ {τ}_{j}} d ( {x}_{j} , {x}_{k} ) - 2 {σ}_{j}^{2} , 0 ) & ( 5 )\end{matrix}$$

$${Δ}_{1 jk} = \frac{1}{\vert {τ}_{j} \vert} d ( {x}_{j} , {x}_{k} ) \qquad ( 6 )$$

where xⱼ=(xⱼ₁, xⱼ₂, . . . , x_{jNc}) is a vector including pixel values of channels of a pixel j (the number of channels is N_{c}), and d (·,·) is an arbitrary distance function that takes two vectors as arguments. The distance function includes any of squared distance, Manhattan distance, Lp distance, Huber distance, Kullback-Leibler distance, and cross entropy, for example.

The similarity index calculator 21 is configured to use the auxiliary signal 35 in calculation of the similarity index 32. Specifically, the similarity index calculator 21 acquires the auxiliary signal 35 from the storage 3. Then, the similarity index calculator 21 calculates the similarity index 32 by using the auxiliary signal 35 based on the following Equation (7).

$$\begin{matrix}[ Formula 6 ] & \\ {Δ}_{2 jk} = max ( \frac{1}{\vert {τ}_{j} \vert} {‖ {v}_{j} - {t}_{k} ‖}_{2}^{2} - 2 {ρ}_{j}^{2} , 0 ) & ( 7 )\end{matrix}$$

where Δ₂ⱼₖ is the similarity index 32 in a case in which the auxiliary signal 35 is used, vⱼ is a template vector of the auxiliary signal 35, and ρⱼ is a noise signal of the auxiliary signal 35.

Also, a weighted arithmetic mean, a weighted geometric mean, a weighted harmonic mean of the similarity index 32 (Δ₁ⱼₖ) obtained from the target signal 30 and the similarity index 32 (Δⱼₖ) obtained from the auxiliary signal 35 may be the final similarity index 32. That is, Δ₁ⱼₖ and Δ₂ⱼₖ may be combined.

The similarity index calculator 21 outputs the similarity index 32 calculated to the filter coefficient calculator 22.

### (Calculation of Filter Coefficient)

The filter coefficient calculator 22 acquires the similarity index 32 from the similarity index calculator 21, and calculates a filter coefficient 33 of a noise reduction filter based on the similarity index 32.

Specifically, the filter coefficient calculator 22 calculates the filter coefficient 33 based on the following Equation (8).

$$\begin{matrix}[ Formula 7 ] & \\ {w}_{1 jk} = {( \frac{exp ( - {Δ}_{1 jk} / {σ}_{j}^{2} )}{{\sum }_{i ∈ {S}_{j}} exp ( - {Δ}_{1 jk} / {σ}_{j}^{2} )} )}^{p} & ( 8 )\end{matrix}$$

where Wᵢⱼₖ is the filter coefficient 33, Sⱼ is a circular filter window that centers the a pixel j, and p is p≥0. The filter window may be a rectangular window.

In this embodiment, the filter coefficient calculator 22 may be configured to calculate the filter coefficient 33 using the target signal 30 together with the similarity index 32. Specifically, the filter coefficient calculator 22 acquires the target signal 30 from the storage 3. Subsequently, the filter coefficient calculator 22 calculates the filter coefficient 33 using the target signal 30 together with the similarity index 32 based on the following Equation (9).

$$\begin{matrix}[ Formula 8 ] & \\ {w}_{2 jk} = {( \frac{{w}_{2 jk} exp ( - {Δ}_{1 jk} / {σ}_{j}^{2} )}{{\sum }_{i ∈ {S}_{j}} {w}_{2 jk} exp ( - {Δ}_{1 jk} / {σ}_{j}^{2} )} )}^{p} & ( 9 )\end{matrix}$$

where W₂ⱼₖ is the filter coefficient 33 calculated by using the target signal 30 together with the similarity index 32, and W₃ⱼₖ is a coefficient of a bilateral filter acquired based on the target signal 30. The coefficient of the bilateral filter can be calculated by a product of “a coefficient based on difference between pixel values” and “a coefficient based on a distance between pixels”.

In this embodiment, the filter coefficient calculator 22 may be configured to calculate the filter coefficient 33 using the auxiliary signal 35. Specifically, the auxiliary signal 35 is acquired from the storage 3. Subsequently, the filter coefficient calculator 22 calculates the filter coefficient 33 using the auxiliary signal 35 based on the following Equation (10).

$$\begin{matrix}[ Formula 9 ] & \\ {w}_{4 jk} = ( \frac{exp ( - {Δ}_{1 jk} / {σ}_{j}^{2} ) exp ( - {Δ}_{2 jk} / {ρ}_{j}^{2} )}{{\sum }_{i ∈ {S}_{j}} exp ( - {Δ}_{1 jk} / {σ}_{j}^{2} ) exp ( - {Δ}_{2 jk} / {ρ}_{j}^{2} )} ) & ( 10 )\end{matrix}$$

where W₄ⱼₖ is the filter coefficient 33 calculated using the auxiliary signal 35. Although the filter coefficient calculator 22 calculates the filter coefficient 33 based on a product of two exponential functions in the above Equation (10), the filter coefficient calculator may be configured to calculate the filter coefficient 33 based on a weighted arithmetic mean, a weighted geometric mean or a weighted harmonic mean of the two exponential functions.

The filter coefficient calculator 22 outputs the filter coefficient 33 calculated to the filter processor 23.

### (Filtering)

The filter processor 23 acquires the target signal 30 from the storage 3. Also, the filter processor 23 acquires the filter coefficient 33 from the filter coefficient calculator 22. Subsequently, the filter processor 23 acquires a low-noise signal 34 by applying the noise reduction filter to the target signal 30 based on the filter coefficient 33. The noise reduction filter is a filter for reducing noise in the target signal 30. The low-noise signal 34 is a signal whose noise is reduced relative to the target signal 30.

In this embodiment, the filter processor 23 acquires the low-noise signal 34 by using the following Equations (11) and (12).

$$\begin{matrix}[ Formula 10 ] & \\ {m}_{j} = {\sum }_{k ∈ {S}_{j}} {\overline{w}}_{jk} {x}_{k} & ( 11 )\end{matrix}$$

$${\overline{w}}_{jk} = \frac{{w}_{jk}}{{\sum }_{i ∈ {S}_{j}} {w}_{jk}} \qquad ( 12 )$$

where mⱼ is the low-noise signal 34, and Wⱼₖ is the filter coefficient 33.

The filter processor 23 may acquire the low-noise signal 34 by using the following Equation (13).

$$\begin{matrix}[ Formula 11 ] & \\ m = arg min [ \frac{1}{2} {‖ z - x ‖}_{2}^{2} + β {\sum }_{j} {\sum }_{k ∈ {S}_{j}} {w}_{jk} ϕ ( {z}_{j} - {z}_{k} ) ] & ( 13 )\end{matrix}$$

where m is the low-noise signal 34, Φ(·) is an arbitrary potential function, and β is a hyperparameter. The potential function includes any of an LP norm function, and a Huber function, for example.

In this embodiment, the filter processor 23 may acquire the low-noise signal 34 by using the noise signal 31 together with the filter coefficient 33. Specifically, the filter processor 23 may acquire the low-noise signal 34 based on the following Equation (14).

$$\begin{matrix}[ Formula 12 ] & \\ m = arg min [ \frac{1}{2} {‖ z - x ‖}_{2}^{2} + β {\sum }_{j} \frac{{σ}_{j}}{{σ}_{x}} {\sum }_{k ∈ {S}_{j}} {w}_{jk} ϕ ( {z}_{j} - {z}_{k} ) ] & ( 14 )\end{matrix}$$

where σₓ is a representative statistic of σ. The representative statistic includes any of a mean, a trimmed mean, a median, the maximum value, and (maximum value+minimum value)/2, for example.

The filter processor 23 may acquire the low-noise signal 34 based on the auxiliary signal 35. Specifically, the filter processor 23 acquires the auxiliary signal 35 from the storage 3. Subsequently, the filter processor 23 may acquire a signal that is acquired by combining the auxiliary signal 35 and the low-noise signal 34 as the low-noise signal 34. The auxiliary signal 35 and the low-noise signal 34 can be combined by using Image Fusion processing. Image Fusion processing is image combination processing including spatial-based combination, frequency-domain combination, and combination using deep learning (learned model).

The filter processor 23 outputs the low-noise signal 34 acquired to the noise signal estimator 20. Subsequently, the noise signal estimator 20 estimates the noise signal 31 based on the low-noise composite signal 36. The noise reduction processing by the noise reducer 2 described above may be repeated a predetermined number of times. If the noise reduction processing is repeated a predetermined number of times, the filter processor 23 outputs the low-noise signal 34 to the combination processor 24. The filter processor 23 may be configured to store the acquired low-noise signal 34 in the storage 3.

### (Combination)

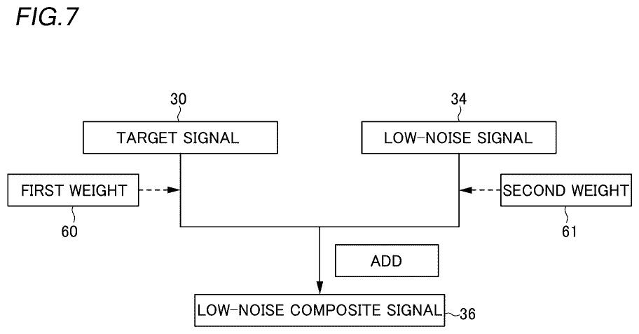

The combination processor 24 acquires the target signal 30 from the storage 3, and acquires the low-noise signal 34 from the filter processor 23. The combination processor 24 acquires the low-noise composite signal 36 by combining the target signal 30 and the low-noise signal 34 for adjustment of noise reduction effect. The low-noise composite signal 36 is a low-noise signal whose noise reduction effect is adjusted. In this embodiment, the combination processor 24 acquires the low-noise composite signal 36 by combining the target signal 30 and the low-noise signal 34 with weights being applied to the target signal and the low-noise signal. Specifically, as shown in FIG. 7, the combination processor 24 (see FIG. 4) multiplies the target signal 30 by the first weight 60, and multiplies the low-noise signal 34 by the second weight 61. Subsequently, the combination processor 24 acquires the low-noise composite signal 36 by adding the target signal 30 that is multiplied by the first weight 60 to the low-noise signal 34 that is multiplied by the second weight 61.

The acquisition of the low-noise composite signal 36 by the combination processor 24 can be represented by the following Equation (15).

$$\begin{matrix}[ Formula 13 ] & \\ {x}^{*} = ( 1 - r ) x + rm & ( 15 )\end{matrix}$$

X* is the low-noise composite signal 36, x is the target signal 30, (1−r) is the first weight 60, r is the second weight 61, and m is the low-noise signal 34.

The combination processor 24 may be configured to acquire the low-noise composite signal 36 based on the following Equation (16) or (17).

$$\begin{matrix}[ Formula 14 ] & \\ {x}^{*} = arg min [ \frac{1}{2} {‖ z - x ‖}_{2}^{2} + β d ( z , m ) ] & ( 16 )\end{matrix}$$

$${x}^{*} = arg min [ \frac{1}{2} {‖ z - x ‖}_{2}^{2} + α \frac{1}{2} {‖ z - m ‖}_{2}^{2} + β {\sum }_{j} {\sum }_{k ∈ {N}_{j}} ( 1 / {d}_{jk} ) ϕ ( {z}_{j} - {z}_{k} ) ] \qquad ( 17 )$$

where Nⱼ is a neighborhood pixel set of a pixel j, and dⱼₖ is a value proportional to a distance between the pixel j and a pixel k.

With reference to FIG. 4 again, the combination is described. In this embodiment, the combination processor 24 may be configured to acquire the low-noise composite signal 36 using at least one of the similarity index 32 and the filter coefficient 33 together with the target signal 30 and the low-noise signal 34.

Specifically, in a case in which the similarity index 32 is used, the combination processor 24 acquires the similarity index 32 from the similarity index calculator 21. Subsequently, the combination processor 24 acquires the low-noise composite signal 36 based on the following Equation (18).

$$\begin{matrix}[ Formula 15 ] & \\ {x}^{*} = arg min [ \frac{1}{2} {‖ z - x ‖}_{2}^{2} + α \frac{1}{2} {‖ z - m ‖}_{2}^{2} + β {\sum }_{j} {\sum }_{k ∈ {N}_{j}} ( 1 / {Δ}_{jk} ) ϕ ( {z}_{j} - {z}_{k} ) ] & ( 18 )\end{matrix}$$

In a case in which the filter coefficient 33 is used, the combination processor 24 acquires the low-noise composite signal 36 based on the following equation (19).

$$\begin{matrix}[ Formula 16 ] & \\ {x}^{*} = arg min [ \frac{1}{2} {‖ z - x ‖}_{2}^{2} + α \frac{1}{2} {‖ z - m ‖}_{2}^{2} + β {\sum }_{j} {\sum }_{k ∈ {N}_{j}} {w}_{jk} ϕ ( {z}_{j} - {z}_{k} ) ] & ( 19 )\end{matrix}$$

The combination processor 24 may acquire the low-noise composite signal 36 based on the auxiliary signal 35. Specifically, the combination processor 24 acquires the auxiliary signal 35 from the storage 3. Subsequently, the combination processor 24 acquires a signal that is acquired by combining the auxiliary signal 35 and the low-noise composite signal 36 as the low-noise composite signal 36. The auxiliary signal 35 and the low-noise composite signal 36 can be combined by using Image Fusion processing.

The combination processor 24 stores the low-noise composite signal 36 acquired in the storage 3. The combination processor 24 may be configured to display the low-noise composite signal 36 on the display 5 (see FIG. 1).

Processing by the noise signal estimator 20, the similarity index calculator 21, the filter coefficient calculator 22, the filter processor 23, and the combination processor 24 may be executed based on the reference dataset 51 (see FIG. 1). The reference dataset 51 includes at least one of a signal of a sample different from a target sample whose target signal 30 is acquired, and a learned model generated by machine learning based on teacher data. The processing by the functional parts 20 to 24 may be executed by using the learned model. The learned model can be generated by learning using input and output of process of each functional part as teacher data.

### (Noise Reduction Processing)

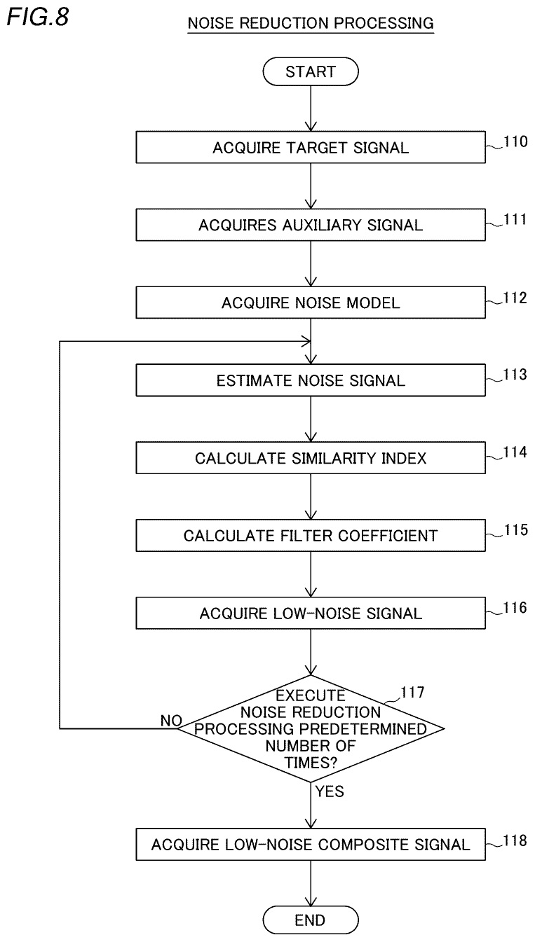

The following description describes processing of the noise reducer 2 (see FIG. 4) for reducing noise in the target signal 30 (see FIG. 4) with reference to FIG. 8.

In step 110, the noise reducer 2 acquires the target signal 30. Specifically, the noise reducer 2 acquires the target signal 30 from the target signal acquirer 1 (see FIG. 1). In a case in which the target signal 30 is stored in the storage 3 (see FIG. 4), the noise reducer 2 may acquire the target signal 30 from the storage 3.

In step 111, the noise reducer 2 accesses the storage 3, which stores the auxiliary signal 35 (see FIG. 4) previously acquired, and acquires the auxiliary signal 35.

In step 112, the noise reducer 2 acquires the noise model 50 (see FIG. 4) of a noise distribution of one of noise caused by an acquisition principle in acquisition of an image signal and noise caused by an apparatus that acquires the image signal. The noise model 50 is previously acquired and stored in the storage 3. Accordingly, the noise reducer 2 accesses the storage 3 storing the noise model 50 (see FIG. 4) of the noise distribution, which is previously acquired, and acquires the noise model 50.

In step 113, the noise signal estimator 20 estimates the noise signal 31 (see FIG. 4) representing an intensity distribution of the noise in the target signal 30 based on the target signal 30. Specifically, the noise signal estimator 20 acquires the low-frequency signal 30a (see FIG. 5) by applying the first filter 40 (see FIG. 5) including the first filter window to the target signal 30. Also, the noise signal estimator 20 acquires the high-frequency signal 30b (see FIG. 5) based on the target signal 30 and the low-frequency signal 30a. The noise signal estimator 20 estimates the noise signal 31 by applying the second filter 41 including the second filter window independent of the first filter window to the high-frequency signal 30b. In this embodiment, the noise signal estimator 20 estimates the noise signal 31 by applying the standard deviation filter that includes the filter window larger than the smoothing filter to the high-frequency signal 30b. In this embodiment, in step 113, the noise signal estimator 20 estimates the noise signal 31 by multiplying the high-frequency signal 30b by the noise model 50 after applying the second filter 41 to the high-frequency signal.

In step 114, the similarity index calculator 21 (see FIG. 4) calculates the similarity index 32 (see FIG. 4) between a predetermined signal that is acquired at a first signal point and a signal that is acquired at a second signal point in proximity to the first signal point based on the target signal 30 and the noise signal 31.

In step 115, the filter coefficient calculator 22 (see FIG. 4) calculates the filter coefficient 33 (see FIG. 4) of the noise reduction filter based on the similarity index 32. In this embodiment, the filter coefficient calculator 22 calculates the filter coefficient 33 using the target signal 30 together with the similarity index 32 in step 115.

In step 116, the filter processor 23 (see FIG. 4) acquires the low-noise signal 34 by applying the noise reduction filter to the target signal 30 based on the filter coefficient 33. In this embodiment, in step 116, the filter processor 23 acquires the low-noise signal 34 by using the noise signal 31 together with the filter coefficient 33.

In step 117, the noise reducer 2 determines whether the noise reduction processing is executed a predetermined number of times. Specifically, the noise reducer 2 determines whether a predetermined number of sets of processes of steps 113 to 116 are executed where the processes of steps 113 to 116 are defined as one set. If the noise reduction processing is executed a predetermined number of times, the procedure goes to step 118. If the noise reduction processing is not executed a predetermined number of times, the procedure goes to step 113. Here, if not, the process of step 113 is executed based on the low-noise signal 34 that is acquired in step 116. That is, a series of processing including the step 113 of estimating the noise signal 31, the step 114 of calculating the similarity index 32, the step 115 of calculating the filter coefficient 33 and the step 116 of acquiring the low-noise signal 34 is repeatedly executed by using the low-noise signal 34 as the target signal 30. The predetermined number of sets may be previously set by users, or may be automatically determined by repeating the set of processes until a change amount of noise reduction becomes not greater than a specified value, for example.

In step 118, the combination processor 24 (see FIG. 4) acquires the low-noise composite signal 36 by combining the target signal 30 and the low-noise signal 34 for adjustment of noise reduction effect. In this embodiment, in step 118, the combination processor 24 acquires the low-noise composite signal 36 by combining the target signal 30 and the low-noise signal 34 with weights being applied to the target signal and the low-noise signal. In step 118, the combination processor 24 acquires the low-noise composite signal 36 by using the noise signal 31 together with the target signal 30 and the low-noise signal 34. Also, in step 118, the combination processor 24 may acquire the low-noise composite signal 36 using one of or both the similarity index 32 and the filter coefficient 33 together with the target signal 30 and the low-noise signal 34.

Subsequently, the noise reducer 2 stores the low-noise composite signal 36 into the storage 3 or displays the low-noise composite signal on the display 5 (see FIG. 1), and the procedure ends.

In this embodiment, the auxiliary signal 35 is used in at least one of estimation of the noise signal 31 (step 113), calculation of the similarity index 32 (step 114), calculation of the filter coefficient 33 (step 115), acquisition of the low-noise signal 34 (step 116), and acquisition of the low-noise composite signal 36 (step 118). Also, the auxiliary signal 35 includes the low-noise signal 34. Accordingly, in this embodiment, the low-noise signal 34 is used as the auxiliary signal 35 in at least one of estimation of the noise signal 31 (step 113), calculation of the similarity index 32 (step 114), calculation of the filter coefficient 33 (step 115), and acquisition of the low-noise signal 34 (step 116). The auxiliary signal 35 may be used in all processes of steps 113 to 116, the auxiliary signal 35 may be used in only any one the steps, or the auxiliary signal 35 may be used in two or more processes of steps 113 to 116.

Also, in this embodiment, processing in at least one of estimation of the noise signal 31 (step 113), calculation of the similarity index 32 (step 114), calculation of the filter coefficient 33 (step 115), acquisition of the low-noise signal 34 (step 116), and acquisition of the low-noise composite signal 36 (step 118) is executed based on the reference dataset 51 (see FIG. 1). The reference dataset 51 may be used in all processes of steps 113 to 116 and 118, the reference dataset 51 may be used in only any one the steps, or the reference dataset 51 may be used in two or more processes of steps 113 to 116 and 118.

The processes of steps 110 to Step 112 can be executed in any order.

### Examples

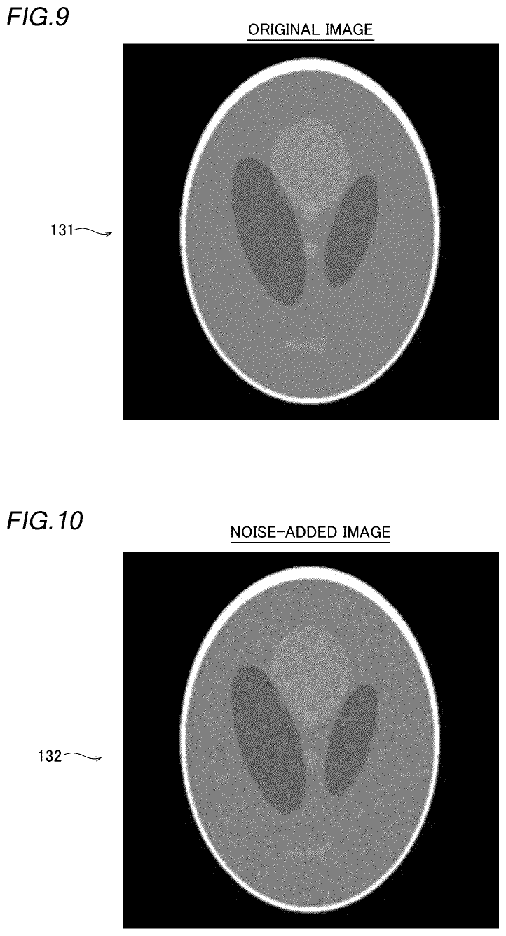

The following description describes an experiment in which reduction of noise while suppressing impairment of a high-frequency component is confirmed with reference to FIGS. 9 to 18.

An original image 131 shown in FIG. 9 is a slice image of a certain cross-section of the Shepp-Logan phantom image, which is frequently used in computer simulation experiments such as X-ray CT and PET. Also, a noise-added image 132 shown in FIG. 10 is an image of the original image 131 to which Gaussian noise with a noise standard deviation of 0.05 was added.

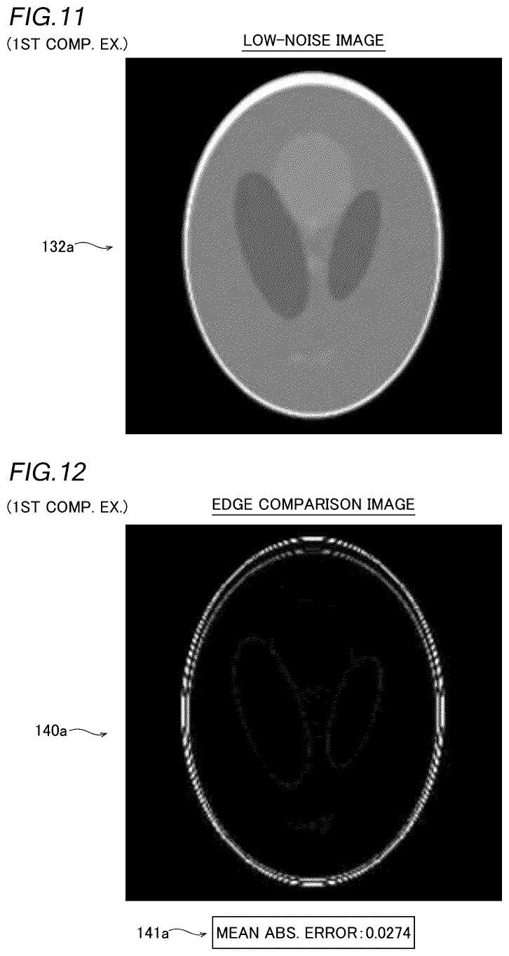

A low-noise image 132a in a first comparative example shown in FIG. 11 is an image that was acquired by using noise estimated by applying a 3×3 standard deviation filter to the original image 131 (see FIG. 9). An edge comparison image 140a in the first comparative example shown in FIG. 12 is an image that was acquired by subtracting the low-noise image 132a in the first comparative example shown in FIG. 11 from the original image 131. A mean absolute error of an edge of a target in the edge comparison image was acquired as a result of evaluation that the high-frequency signal 30b was not impaired. The smaller the value of the mean absolute error, the smaller the error from the original image 131, which means that the high-frequency signal 30b is not impaired. In the first comparative example, a mean absolute error 141a of the edge comparison image 140a was 0.0274.

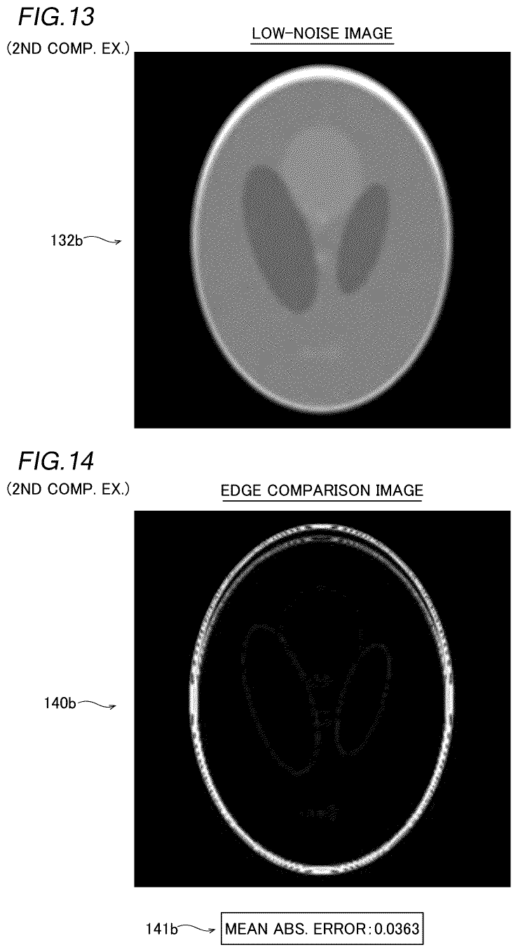

A low-noise image 132b in a second comparative example shown in FIG. 13 is an image that was acquired by using noise estimated by applying a 5×5 standard deviation filter to the original image 131 (see FIG. 9). An edge comparison image 140b in the second comparative example shown in FIG. 14 is an image that was acquired by subtracting the low-noise image 132b in the second comparative example shown in FIG. 13 from the original image 131. A mean absolute error 141b acquired in the edge comparison image 140b was 0.0363. When a filter window of the standard deviation filter was increased to improve accuracy of noise estimation, it has been confirmed that a high-frequency component is impaired.

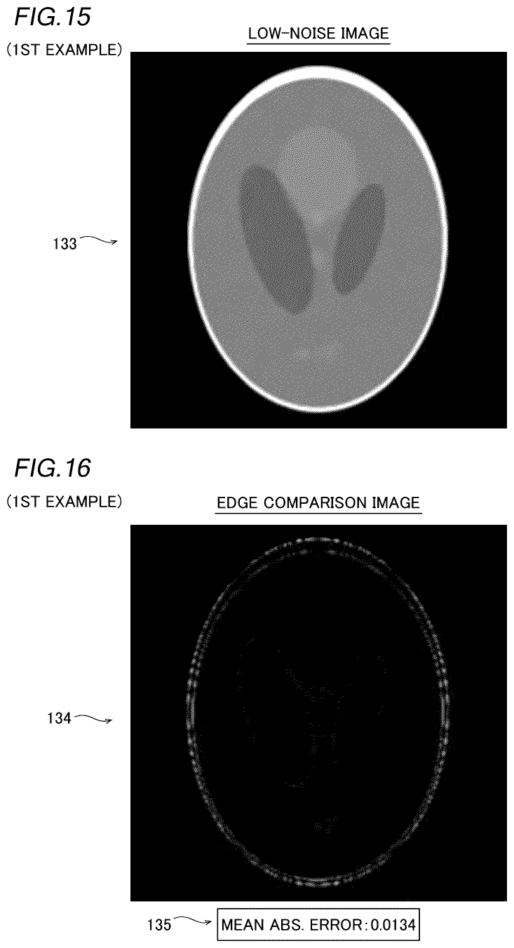

A low-noise image 133 in a first example shown in FIG. 15 is an image that was acquired by estimating the noise signal 31 by using a smoothing filter and a standard deviation filter that have different sizes. Specifically, a low-frequency signal 30a (see FIG. 5) was acquired by applying a 3×3 mean value filter to the original image 131 (see FIG. 9). A high-frequency signal 30b (see FIG. 5) was acquired by subtracting the acquired low-frequency signal 30a from the original image 131. The noise signal 31 was estimated by applying a 5×5 standard deviation filter to the acquired high-frequency signal 30b. Subsequently, the low-noise signal 34 (see FIG. 4) was acquired based on the configuration of the aforementioned embodiment. A low-noise image 133 shown in FIG. 15 is an image based on the low-noise signal 34.

An edge comparison image 134 in the first example shown in FIG. 16 is an image that was acquired by subtracting the low-noise image 133 in the first example shown in FIG. 15 and the original image 131 (see FIG. 9). A mean absolute error 135 acquired in the edge comparison image 134 was 0.0134. This value is smaller than the value of the mean absolute error 141a in the first comparative example (0.0274) and the value of the mean absolute error 141b in the second comparative example (0.0363). It has been confirmed that impairment of the high-frequency component can be suppressed by making size of the a window of the smoothing filter different from size of a filter window of the standard deviation filter.

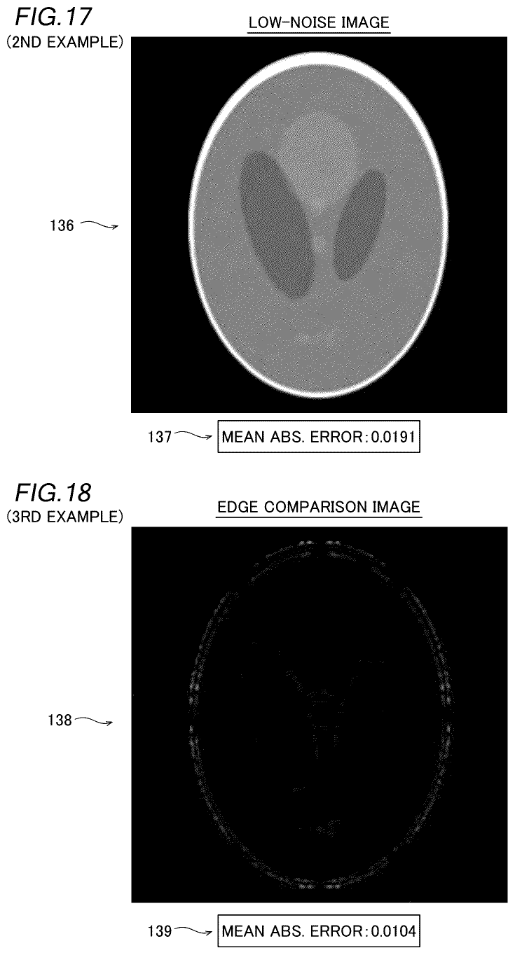

A low-noise image 136 in a second example shown in FIG. 17 is an image that was acquired by weighting the low-noise image 133 (see FIG. 15) acquired by the first example and the original image 131 (see FIG. 9). Specifically, the low-noise image 136 in the second example was acquired by adding the low-noise image 133 that was multiplied by a weight of 0.7 to the original image 131 that was multiplied by a weight of 0.3. An edge comparison image was acquired based on the low-noise image 136 in the second example, and a mean absolute error 137 acquired was 0.0191. This value is smaller than the value of the mean absolute error 141a in the first comparative example (0.0274) and the value of the mean absolute error 141b in the second comparative example (0.0363). As a result, it has been confirmed that a high-frequency component can be suppressed also in a configuration according to the second example in which the weighted low-noise image 136 is added to the weighted original image 131.

An edge comparison image 138 in a third example shown in FIG. 18 is an edge comparison image that was obtained based on the low-noise image that is acquired by repeating noise reduction processing. Specifically, the noise signal 31 (see FIG. 4) was estimated by applying a 5×5 standard deviation filter to a difference image between the original image 131 (see FIG. 9) and the low-noise image 133 (see FIG. 15) in the first example so that the low-noise signal 34 (see FIG. 4) was acquired as the noise signal based on the configuration of the aforementioned embodiment. Subsequently, an edge comparison image 138 in a third example was acquired by subtracting the low-noise image from the original image 131. In other words, the low-noise image in the third example is an image that was acquired by executing the noise reduction processing twice.

A mean absolute error 139, which was acquired based on the edge comparison image 138 in the third example, was 0.0104. This result is smaller than the value of the mean absolute error 141a in the first comparative example (0.0274) and the value of the mean absolute error 141b in the second comparative example (0.0363). Also, this result is smaller than the value of the mean absolute error 135 in the first example is (0.0134). Consequently, it has been confirmed that impairment of the high-frequency component can be suppressed by repeating noise reduction processing.

### Advantages of the Embodiment

In this embodiment, the following advantages are obtained.

As described above, a noise reduction processing method according to this embodiment is a method for reducing noise in a target signal 30 including a step 113 of estimating a noise signal 31 representing an intensity distribution of the noise in the target signal 30 based on the target signal 30; a step 114 of calculating a similarity index 32 between a predetermined signal that is acquired at a first signal point and a signal that is acquired at a second signal point in proximity to the first signal point based on the target signal 30 and the noise signal 31; a step 115 of calculating a filter coefficient 33 of a noise reduction filter based on the similarity index 32; a step 116 of acquiring a low-noise signal 34 by applying the noise reduction filter to the target signal 30 based on the filter coefficient 33, wherein in the step 113 of estimating the noise signal 31, a low-frequency signal 30a is acquired by applying a first filter 40 including a first filter window to the target signal 30, a high-frequency signal 30b is acquired based on the target signal 30 and the low-frequency signal 30a, and the noise signal 31 is estimated by applying a second filter 41 including a second filter window independent of the first filter window to the high-frequency signal 30b.

Accordingly, because size of the first filter window and size of the second filter window can be set independently of each other, it is possible to suppress impairment of the high-frequency component of the target. Also, the noise signal 31 is estimated by applying a second filter 41 including a second filter window independent of the first filter window, which is used in acquisition of the low-frequency signal 30a, to the high-frequency signal 30b. Accordingly, the noise signal 31 can be estimated by setting the size of the first filter window and the size of the second filter window can be set depending on the target signal 30. For this reason, because a statistical variation of noise levels in the noise signal 31 estimated can be suppressed by changing the size of the second filter window depending on the target signal 30, it is possible to improve estimation accuracy of the noise signal 31. Consequently, it is possible to improve accuracy of the similarity index 32 acquired based on the noise signal 31. In addition, because the accuracy of the similarity index 32 can be improved, it is possible to accurately calculate the filter coefficient 33. Therefore, it is possible to reduce noise while suppressing impairment of the high-frequency component of the target.

As described above, a noise reduction processing apparatus 100 according to this embodiment is an apparatus for reducing noise in a target signal 30 including a target signal acquirer 1 for acquiring the target signal 30; and a noise reducer 2 for reducing noise in the target signal 30, wherein the noise reducer 2 is configured to acquire a low-frequency signal 30a by applying a first filter 40 including a first filter window to the target signal 30, to acquire a high-frequency signal 30b based on the target signal 30 and the low-frequency signal 30a and to estimate the noise signal 31 by applying a second filter 41 including a second filter window independent of the first filter window to the high-frequency signal 30b, to calculate a similarity index 32 between a predetermined signal that is acquired at a first signal point and a signal that is acquired at a second signal point in proximity to the first signal point based on the target signal 30 and the noise signal 31, to calculate a filter coefficient 33 of a noise reduction filter based on the similarity index 32, and to acquire a low-noise signal 34 by applying the noise reduction filter to the target signal 30 based on the filter coefficient 33.

Accordingly, similar to the aforementioned noise reduction processing method, it is possible to provide a noise reduction processing apparatus 100 capable of reducing noise while suppressing impairment of a high-frequency component of a target.

Also, as described above, a noise reduction processing method according to a this embodiment is a method for reducing noise in a target signal 30 including the step 113 of estimating a noise signal 31 representing an intensity distribution of the noise in the target signal 30 based on the target signal 30; the step 114 of calculating a similarity index 32 between a predetermined signal that is acquired at a first signal point and a signal that is acquired at a second signal point in proximity to the first signal point based on the target signal 30 and the noise signal 31; the step 115 of calculating a filter coefficient 33 of a noise reduction filter based on the similarity index 32; the step 116 of acquiring a low-noise signal 34 by applying the noise reduction filter to the target signal 30 based on the filter coefficient 33; and a step 118 of acquiring a low-noise composite signal 36 by combining the target signal 30 and the low-noise signal 34 for adjustment of noise reduction effect.

Accordingly, the combination of the target signal 30 and the low noise signal 34 can achieve both suppression of impairment of the high-frequency component of the target signal due to the target signal 30, and noise reduction using the low-noise signal 34. As a result, it is possible to provide a noise reduction processing method capable of reducing noise while suppressing impairment of a high-frequency component of a target. Also, the low-noise composite signal 36 is acquired by combining the target signal 30 and the low-noise signal 34 for adjustment of noise reduction effect. Accordingly, the noise reduction effect can be easily adjusted by adjusting a combination ratio between the target signal 30 and the low-noise signal 34. Consequently, it is possible to reduce time required for adjustment of the noise reduction effect as compared with a configuration in which parameters are changed and a series of processes for acquiring a low-noise signal 34 from a target signal 30 is executed again.

Also, as described above, a noise reduction processing apparatus 100 according to this embodiment is an apparatus for reducing noise in a target signal 30 including a target signal acquirer 1 for acquiring the target signal 30; and a noise reducer 2 for reducing noise in the target signal 30, wherein the noise reducer 2 is configured to estimate a noise signal 31 representing an intensity distribution of the noise in the target signal 30 based on the target signal 30, to calculate a similarity index 32 between a predetermined signal that is acquired at a first signal point and a signal that is acquired at a second signal point in proximity to the first signal point based on the target signal 30 and the noise signal 31, to calculate a filter coefficient 33 of a noise reduction filter based on the similarity index 32, to acquire a low-noise signal 34 by applying the noise reduction filter to the target signal 30 based on the filter coefficient 33, and to acquire a low-noise composite signal 36 by combining the target signal 30 and the low-noise signal 34 for adjustment of noise reduction effect.

Accordingly, similar to the aforementioned noise reduction processing method, it is possible to provide a noise reduction processing apparatus 100 capable of reducing noise while suppressing impairment of a high-frequency component of a target. In addition, it is possible to provide a noise reduction processing apparatus 100 capable of reducing time required for adjustment of the noise reduction effect as compared with a configuration in which parameters are changed and a series of processes for acquiring a low-noise signal 34 from a target signal 30 is executed again.

In addition, following additional advantages can be obtained by the aforementioned embodiment added with configurations discussed below.

That is, in this embodiment, as described above, the first filter 40 includes a smoothing filter; the second filter 41 includes a standard deviation filter; and in the step 113 of estimating the noise signal 31, the noise signal 31 is estimated by applying the standard deviation filter that is different from the smoothing filter to the high-frequency signal 30b. Accordingly, the noise signal 31 is estimated from the high-frequency signal 30b by applying the standard deviation filter that includes a filter window larger than the smoothing filter to the high-frequency signal, for example, and as a result it is possible to improve estimation accuracy of the noise signal 31. Consequently, it is possible to more accurately reduce noise.

Also, in this embodiment, as described above, the target signal 30 is a two- or higher-dimensional image signal; the noise reduction processing method further includes a step 112 of acquiring, based on a noise distribution of one of noise caused by an acquisition principle in acquisition of the image signal and noise caused by an apparatus that acquires the image signal, a noise model 50 of the noise distribution; and in the step 113 of estimating the noise signal 31, the noise signal 31 is estimated by multiplying the high-frequency signal by the noise model 50 following to the applying the second filter 41 to the high-frequency signal 30b. Accordingly, it is possible to estimate the noise signal 31 on which a noise distribution of one of noise caused by an acquisition principle in acquisition of an image signal and noise caused by an apparatus that acquires the image signal is reflected by the noise model 50. Consequently, it is possible to further improve estimation accuracy of the noise signal 31.

Also, in this embodiment, as described above, a series of processing including the step 113 of estimating the noise signal 31, the step 114 of calculating the similarity index 32, the step 115 of calculating the filter coefficient 33 and the step 116 of acquiring the low-noise signal 34 is repeatedly executed by using the low-noise signal 34 as the target signal 30. Accordingly, because noise reduction processing is executed based on a low-noise signal 34 whose noise is reduced relative to the target signal 30, it is possible further reduce noise as compared with a configuration in which noise reduction processing is executed only once for the target signal 30.

Also, in this embodiment, as described above, in step 116 of acquiring the low-noise signal 34, the low-noise signal 34 is acquired by using the noise signal 31 together with the filter coefficient 33. Accordingly, the low-noise signal 34 is acquired by using the noise signal 31 together with the similarity index 32 and the filter coefficient 33, the noise signal 31 can be used as a parameter in calculation of the low-noise signal 34. Consequently, because the low-noise signal 34 on which a noise distribution of the target signal 30 is reflected can be acquired, it is possible to acquire the low-noise signal 34 whose noise is accurately reduced as compared with a configuration in which the filter coefficient 33 is calculated only from the target signal 30.

Also, in this embodiment, as described above, in the step 115 of calculating the filter coefficient 33, the filter coefficient 33 is acquired by using the target signal 30 together with the similarity index 32. Accordingly, for example, the filter coefficient 33 can be calculated based on the filter coefficient calculated from the target signal 30 itself and the similarity index 32. Consequently, likelihood of the filter coefficient 33 can be improved by calculating the filter coefficient from the target signal 30 itself can be further used as a parameter used to calculate the filter coefficient 33.

Also, in this embodiment, as described above, a step 111 is further provided of acquiring an auxiliary signal 35 of a common target whose target signal 30 has been acquired, the auxiliary signal being acquired by an apparatus that is different from an apparatus that captures the target signal 30, under an acquisition condition that is different from a condition that the target signal 30 is acquired, or under a processing condition that is different from processing condition that the target signal 30 is acquired, wherein processing in at least one of estimation of the noise signal 31 in the step 113 of estimating the noise signal 31, calculation of the similarity index 32 in the step 114 of calculating the similarity index 32, calculation of the filter coefficient 33 in the step 115 of calculating the filter coefficient 33, and acquisition of the low-noise signal 34 in the step 116 of acquiring the low-noise signal 34 is executed by using the auxiliary signal 35.

The auxiliary signal 35 is a signal that is acquired by an apparatus different from the target signal 30, or under an acquisition condition or a processing condition from the target signal, and includes information on the common target whose target signal 30 has been acquired but different from the target signal 30. Accordingly, the noise signal 31 can be estimated while easily preserving the high-frequency signal 30b of the target by using a high-resolution signal as the auxiliary signal 35 in estimation of the noise signal 31 from the low-resolution target signal 30, for example. For this reason, it is possible to improve estimation accuracy of the noise signal 31. Also, the accuracy of the similarity index 32 can be improved by using a signal that has a higher SN ratio than the noise signal 31 as the auxiliary signal 35 to calculate the similarity index 32, for example, as compared with a case in which the similarity index 32 is calculated from the noise signal 31. Also, because the number of parameters used to calculate the filter coefficient 33 can be increased by using the auxiliary signal 35 in calculation of the filter coefficient 33, for example, it is possible to improve likelihood of the filter coefficient 33. Also, noise can be reduced while improving visibility of a boundary between the target and a background by combining the auxiliary signal 35, which has a high resolution, with the low-noise signal 34 in acquisition of the low-noise signal 34, for example. Because the auxiliary signal 35 is used in at least one of processes of the steps, processing accuracy of the step that uses the auxiliary signal 35 can be improved as compared with a case in which the auxiliary signal 35 is not used, and as a result noise can be accurately reduced while suppressing impairment of a high-frequency component of the target signal 30.

Also, in this embodiment, as described above, the auxiliary signal 35 includes the low-noise signal 34; and processing in at least one of estimation of the noise signal 31 in the step 113 of estimating the noise signal 31, calculation of the similarity index 32 in the step 114 of calculating the similarity index 32, calculation of the filter coefficient 33 in the step 115 of calculating the filter coefficient 33, and acquisition of the low-noise signal 34 in the step 116 of acquiring the low-noise signal 34 is executed by using the low-noise signal 34 as the auxiliary signal 35. Accordingly, even in a case in which it is difficult to acquire a signal by using an apparatus that is different from an apparatus that captures the target signal 30, under an acquisition condition that is different from a condition that the target signal 30 is acquired, or under a processing condition that is different from processing condition that the target signal 30 is acquired, the low-noise signal 34 can be used as the auxiliary signal 35. Consequently, even in a case in which it is difficult to acquire a signal by using an apparatus that is different from an apparatus that captures the target signal 30, under an acquisition condition that is different from a condition that the target signal 30 is acquired, or under a processing condition that is different from processing condition that the target signal 30 is acquire, noise can be accurately reduced while suppressing impairment of a high-frequency component of the target signal 30.

Also, in this embodiment, as described above, processing in at least one of estimation of the noise signal 31 in the step 113 of estimating the noise signal 31, calculation of the similarity index 32 in the step 114 of calculating the similarity index 32, calculation of the filter coefficient 33 in the step 115 of calculating the filter coefficient 33, and acquisition of the low-noise signal 34 in the step 116 of acquiring the low-noise signal 34 is executed based on a reference dataset 51. Accordingly, processing speed can be improved without changing the entire configuration of noise reduction processing from a configuration of noise reduction processing that does not use the reference dataset 51 by replacing a process of a step that has a slow processing speed with a process that uses the reference dataset 51, for example. Because the processing speed can be improved in the step that has a low processing speed, and as a result it is possible to improve the overall processing speed of the noise reduction processing.

Also, in this embodiment, as described above, a step 118 is further provided of acquiring a low-noise composite signal 36 by combining the target signal 30 and the low-noise signal 34 with weights being applied to the target signal and the low-noise signal for adjustment of noise reduction effect. Accordingly, the noise reduction effect can be easily adjusted by adjusting the weights applied to the target signal 30 whose noise is not reduced and the low-noise signal 34 whose noise is not reduced. Consequently, it is possible to reduce time required for adjustment of the noise reduction effect as compared with a configuration in which parameters are changed and a series of processes for acquiring a low-noise signal 34 from a target signal 30 is executed again.

Also, in this embodiment, as described above, in the step 118 of acquiring the low-noise composite signal 36, the low-noise composite signal 36 is acquired by combining the target signal 30 and the low-noise signal 34 with weights being applied to the target signal and the low-noise signal. Accordingly, the noise reduction effect can be more easily adjusted by adjusting the weight applied to the target signal 30 whose noise is not reduced and the weight applied to the low-noise signal 34 whose noise is not reduced.

Also, in this embodiment, as described above, in the step 118 of acquiring the low-noise composite signal 36, the low-noise composite signal 36 is acquired by using the noise signal 31 together with the target signal 30 and the low-noise signal 34. Accordingly, because the target signal 30 and the low-noise signal 34 can be combined with each other with a noise distribution being reflected on the target signal and the low-noise signal based on the noise signal 31, it possible to provide detailed adjustment of the noise reduction effect.

Also, in this embodiment, as described above, in the step 118 of acquiring the low-noise composite signal 36, the low-noise composite signal 36 is acquired by using at least one of the similarity index 32 and the filter coefficient 33 together with the target signal 30 and the low-noise signal 34. Accordingly, at least one of the similarity index 32 and the filter coefficient 33 acquired based on the target signal 30 can be used as a coefficient in calculation of the low-noise composite signal 36. As a result, because the coefficient based on the target signal 30 can be used as a parameter dissimilar to a configuration in which neither the similarity index 32 nor the filter coefficient 33 is used, it is possible to improve accuracy of the low-noise composite signal 36.

Also, in this embodiment, as described above, a step 112 is further provided of acquiring an auxiliary signal 35 of a common target whose target signal 30 has been acquired, the auxiliary signal being acquired by an apparatus that is different from an apparatus that captures the target signal 30, under an acquisition condition that is different from a condition that the target signal 30 is acquired, or under a processing condition that is different from processing condition that the target signal 30 is acquired, wherein processing in at least one of estimation of the noise signal 31 in the step 113 of estimating the noise signal 31, calculation of the similarity index 32 in the step 114 of calculating the similarity index 32, calculation of the filter coefficient 33 in the step 115 of calculating the filter coefficient 33, acquisition of the low-noise signal 34 in the step 116 of acquiring the low-noise signal 34, and acquisition of the low-noise composite signal 36 in the step 118 of acquiring the low-noise composite signal 36 is executed by using the auxiliary signal 35.

Accordingly, in a case in which processing in processing in estimation of the noise signal 31 in the step 113 of estimating the noise signal 31, calculation of the similarity index 32 in the step 114 of calculating the similarity index 32, calculation of the filter coefficient 33 in the step 115 of calculating the filter coefficient 33, and acquisition of the low-noise signal 34 in the step 116 of acquiring the low-noise signal 34 is executed by using the auxiliary signal 35, it is possible to accurately reduce noise while suppressing impairment of the high-frequency component of the target signal 30 as described above. Also, in a case in which the auxiliary signal 35 is used in acquisition of the low-noise composite signal 36, noise can be reduced while improving visibility of a boundary between the target and a background by combining the auxiliary signal 35, which has a high resolution, with the low-noise signal 34, for example. Consequently, it is possible to accurately reduce noise while suppressing impairment of the high-frequency component of the target signal 30 as compared with a case in which the auxiliary signal 35 is not used also in the step 118 of acquiring the low-noise composite signal 36.

Also, in this embodiment, as described above, processing in at least one of estimation of the noise signal 31 in the step 113 of estimating the noise signal 31, calculation of the similarity index 32 in the step 114 of calculating the similarity index 32, calculation of the filter coefficient 33 in the step 115 of calculating the filter coefficient 33, acquisition of the low-noise signal 34 in the step 116 of acquiring the low-noise signal 34, and acquisition of the low-noise composite signal 36 in the step 118 of acquiring the low-noise composite signal 36 is executed based on a reference dataset 51. Accordingly, processing speed can be improved without changing the entire configuration of noise reduction processing from a configuration of noise reduction processing that does not use the reference dataset 51 by replacing a process of a step that has a slow processing speed with a process that uses the reference dataset 51, for example. Because the processing speed can be improved in the step that has a low processing speed, and as a result it is possible to improve the overall processing speed of the noise reduction processing and processing for adjusting the noise reduction effect.

### Modified Embodiments

The embodiment and the example disclosed this time must be considered as illustrative in all points and not restrictive. The scope of the present invention is not shown by the above description of the embodiment and the example but by the scope of claims for patent, and all modifications (modified embodiments) within the meaning and scope equivalent to the scope of claims for patent are further included.

While the example in which the noise signal estimator 20 estimates the noise signal 31 by using a smoothing filter has been shown in the aforementioned embodiment, the present invention is not limited to this. For example, the noise intensity estimator may be configured to estimate the noise signal 31 by solving an optimization problem of the following Equation (20).

$$\begin{matrix}[ Formula 17 ] & \\ min \frac{1}{2} {‖ x - y ‖}_{2}^{2} + R ( x ) & ( 20 )\end{matrix}$$

where y is the target signal 30, and R(·) is a regularization function. The regularization function includes one of a Quadratic function, a Huber function, and a Total Variation function, for example.

While the example in which the noise signal estimator 20 estimates the noise signal 31 by multiplying the high-frequency signal 30b by the noise model 50 after applying the second filter 41 to the high-frequency signal has been shown in the aforementioned embodiment, the present invention is not limited to this. For example, the noise signal estimator 20 does not necessarily multiply the noise signal 31 by the noise model 50. However, if the noise signal 31 is not multiplied by the noise model 50, the noise signal 31 is estimated based on a noise distribution of neither noise caused by an acquisition principle in acquisition of the image signal nor noise caused by an apparatus that acquires the image signal estimation accuracy of the noise signal 31 decreases. For this reason, it is preferable that the noise signal estimator 20 is configured to multiply the noise signal 31 by the noise model 50.

While the example in which the noise reducer 2 repeatedly executes a series of processing including the step 113 of estimating the noise signal 31, the step 114 of calculating the similarity index 32, the step 115 of calculating the filter coefficient 33 and the step 116 of acquiring the low-noise signal 34 by using the low-noise signal 34 as the target signal 30 has been shown in the aforementioned embodiment, the present invention is not limited to this. For example, the noise reducer 2 does not necessarily repeatedly execute the steps 113 to 116.

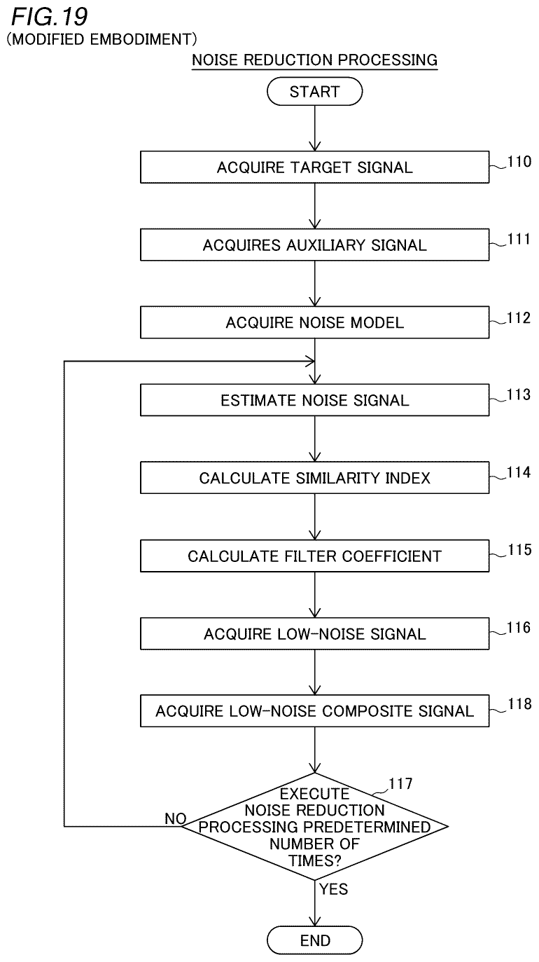

While the example in which the noise reducer 2 repeatedly executes a series of processing including the steps 113 to 116 has been shown in the aforementioned embodiment, the present invention is not limited to this. For example, as shown in FIG. 19, the noise reducer may be configured to repeatedly execute a series of processing including the steps 113 to 116 and 118. In other words, the repeat determination process of the step 117 can be executed following to the step 118. Each step in a flowchart shown in FIG. 19 is a step to be executed similarly to corresponding one of the steps in the aforementioned embodiment.

While the example in which the filter processor 23 acquires the low-noise signal 34 by using the noise signal 31 together with the filter coefficient 33 has been shown in the aforementioned embodiment, the present invention is not limited to this. For example, the filter processor may be configured to acquire the low-noise signal 34 by using the filter coefficient 33 without using the noise signal 31. However, if the filter processor acquires the low-noise signal 34 by using the filter coefficient 33 without using the noise signal 31, it is difficult to accurately reduce noise in the low-noise signal 34. For this reason, it is preferable that the filter processor 23 is configured to acquire the low-noise signal 34 by using the noise signal 31 together with the filter coefficient 33.

While the example in which the filter coefficient calculator 22 calculates the filter coefficient 33 using the target signal 30 together with the similarity index 32 has been shown in the aforementioned embodiment, the present invention is not limited to this. For example, the filter coefficient calculator may be configured to acquire the filter coefficient 33 based on the similarity index 32 without using the target signal 30. However, if the filter coefficient calculator is configured to acquire the filter coefficient 33 based on the similarity index 32 without using the target signal 30, likelihood of the filter coefficient 33 decreases. For this reason, it is preferable that the filter coefficient calculator 22 is configured to calculate the filter coefficient 33 using the target signal 30 together with the similarity index 32.

While the example in which the auxiliary signal 35 includes the low-noise signal 34 has been shown in the aforementioned embodiment, the present invention is not limited to this. For example, the auxiliary signal 35 may not include the low-noise signal 34. However, if the auxiliary signal 35 is configured to include no low-noise signal 34, it is difficult to acquire the auxiliary signal 35 corresponding to a target signal 30 that is difficult to be acquired by an apparatus that is different from an apparatus that captures the target signal 30, under an acquisition condition that is different from a condition that the target signal 30 is acquired, or under a processing condition that is different from processing condition that the target signal 30 is acquired. For this reason, it is preferable that the auxiliary signal 35 includes the low-noise signal 34.

While the example in which the noise reducer 2 acquires the low-noise composite signal 36 by combining the target signal 30 and the low-noise signal 34 with weights being applied to the target signal and the low-noise signal for adjustment of noise reduction has been shown in the aforementioned embodiment, the present invention is not limited to this. For example, the noise reducer may be configured to acquire no low-noise composite signal 36. However, in a case in which the noise reducer is configured to acquire no low-noise composite signal 36, it is necessary to change parameters and to execute noise reduction processing again. In this case, time required for the noise reduction processing increases. For this reason, it is preferable that the noise reducer 2 is configured to acquire the low-noise composite signal 36.

While the example in which the combination processor 24 acquires the low-noise composite signal 36 by combining the target signal 30 and the low-noise signal 34 with weights being applied to the target signal and the low-noise signal has been shown in the aforementioned embodiment, the present invention is not limited to this. For example, the combination processor may be configured to acquire the low-noise composite signal 36 by combining the target signal 30 and the low-noise signal 34 without weights being applied to the target signal and the low-noise signal. However, if the combination processor is configured to acquire the low-noise composite signal 36 by combining the target signal 30 and the low-noise signal 34 without weights being applied to the target signal and the low-noise signal, flexibility of adjustment of noise reduction effect decreases. For this reason, it is preferable that the combination processor 24 is configured to acquire the low-noise composite signal 36 by combining the target signal 30 and the low-noise signal 34 with weights being applied to the target signal and the low-noise signal.

While the example in which the combination processor 24 acquires the low-noise composite signal 36 by using the noise signal 31 together with the target signal 30 and the low-noise signal 34 has been shown in the aforementioned embodiment, the present invention is not limited to this. For example, the combination processor may be configured to acquire the low-noise composite signal 36 by using the target signal 30 and the low-noise signal 34 without using the noise signal 31. However, if the combination processor is configured to acquire the low-noise composite signal 36 by using the target signal 30 and the low-noise signal 34 without using the noise signal 31, the target signal 30 and the low-noise signal 34 cannot be combined with each other with a noise distribution being reflected on the target signal and the low-noise signal based on the noise signal 31. For this reason, it is difficult to provide detailed adjustment of the noise reduction effect of the low-noise composite signal 36. To address this, it is preferable that the combination processor 24 is configured to acquire the low-noise composite signal 36 by using the noise signal 31 together with the target signal 30 and the low-noise signal 34.

While the example in which the combination processor 24 is configured to acquire the low-noise composite signal 36 using at least one of the similarity index 32 and the filter coefficient 33 together with the target signal 30 and the low-noise signal 34 has been shown in the aforementioned embodiment, the present invention is not limited to this. For example, the combination processor may be configured to acquire the low-noise composite signal 36 by using the target signal 30 and the low-noise signal 34 without using the similarity index 32 and the filter coefficient 33. However, if the combination processor is configured to acquire the low-noise composite signal 36 by using the target signal 30 and the low-noise signal 34 without using the similarity index 32 and the filter coefficient 33, accuracy of the low-noise composite signal 36 decreases. For this reason, it is preferable that the combination processor 24 is configured to acquire the low-noise composite signal 36 using at least one of the similarity index 32 and the filter coefficient 33 together with the target signal 30 and the low-noise signal 34.

While the example in which the low-noise signal 34 is used as the auxiliary signal 35 has been shown in the aforementioned embodiment, the present invention is not limited to this. For example, the low-noise composite signal 36 may be used as the auxiliary signal. Also, the noise reduction processing can be repeated by using the low-noise composite signal 36 as the target signal 30.

While the example in which the filter window (second filter window) of the standard deviation filter (second filter) is larger than the filter window (first filter window) of the smoothing filter (first filter) has been shown in the aforementioned embodiment, the present invention is not limited to this. The size of the first filter window and the size of the second filter window can be set in accordance with the target signal 30. That is, the size of the second filter window may be smaller than the size of the first filter window or equal to the size of the first filter window.

Also, the target signals 30 shown in Table 52 in the aforementioned embodiment are merely illustrative, and the target signals 30 can include signals other than the signals shown in Table 52. Also, the auxiliary signals 35 shown in Table 53 are merely illustrative, and the auxiliary signals 35 can include signals other than the signals shown in Table 53.

While the procedure of the noise reduction processing of the noise reducer 2 has been illustratively described by using a flow-driven type flowchart in which processes are sequentially performed along a processing flow for ease of illustration in the aforementioned embodiment, the present invention is not limited to this. In the present invention, processes of the noise reduction processing of the noise reducer 2 can be executed in event-driven type processing in which the processes are executed on an event-by-event basis. In this case, the processes can be executed fully in the event-driven type processing or in combination of the event-driven type processing and flow-driven-step type processing.

### [Modes]

The aforementioned exemplary embodiment will be understood as concrete examples of the following modes by those skilled in the art.

### (Mode Item 1)

A noise reduction processing method for reducing noise in a target signal according to mode item 1 is a noise reduction processing method including a step of estimating a noise signal representing an intensity distribution of the noise in the target signal; a step of calculating a similarity index between a predetermined signal that is acquired at a first signal point and a signal that is acquired at a second signal point in proximity to the first signal point based on the target signal and the noise signal; a step of calculating a filter coefficient of a noise reduction filter based on the similarity index; a step of acquiring a low-noise signal by applying the noise reduction filter to the target signal based on the filter coefficient, wherein in the step of estimating the noise signal, a low-frequency signal is acquired by applying a first filter including a first filter window to the target signal, a high-frequency signal is acquired based on the target signal and the low-frequency signal, and the noise signal is estimated by applying a second filter including a second filter window independent of the first filter window to the high-frequency signal.

### (Mode Item 2)

In the noise reduction processing method according to mode item 1, the first filter includes a smoothing filter; the second filter includes a standard deviation filter; and in the step of estimating the noise signal, the noise signal is estimated by applying the standard deviation filter, which is different from the smoothing filter, to the high-frequency signal.

### (Mode Item 3)

In the noise reduction processing method according to mode item 1 or 2, the target signal is a two- or higher-dimensional image signal; the noise reduction processing method further includes acquiring, based on a noise distribution of one of noise caused by an acquisition principle in acquisition of the image signal and noise caused by an apparatus that acquires the image signal, a noise model of the noise distribution; and in the step of estimating the noise signal, the noise signal is estimated by multiplying the high-frequency signal by the noise model following to the applying the second filter to the high-frequency signal.

### (Mode Item 4)

In the noise reduction processing method according to any of mode items 1 to 3, a series of processing including the step of estimating the noise signal, the step of calculating the similarity index, the step of calculating the filter coefficient and the step of acquiring the low-noise signal is repeatedly executed by using the low-noise signal as the target signal.

### (Mode Item 5)

In the noise reduction processing method according to any of mode items 1 to 4, in the step of acquiring the low-noise signal, the low-noise signal is acquired by using the noise signal together with the filter coefficient.

### (Mode Item 6)

In the noise reduction processing method according to any of mode items 1 to 5, in the step of calculating the filter coefficient, the filter coefficient is calculated by using the target signal together with the similarity index.

### (Mode Item 7)

In the noise reduction processing method according to any of mode items 1 to 6, a step of acquiring an auxiliary signal of a common target whose target signal has been acquired, the auxiliary signal being acquired by an apparatus that is different from an apparatus that captures the target signal, under an acquisition condition that is different from a condition that the target signal is acquired, or under a processing condition that is different from processing condition that the target signal is acquired is further provided; and processing in at least one of estimation of the noise signal in the step of estimating the noise signal, calculation of the similarity index in the step of calculating the similarity index, calculation of the filter coefficient in the step of calculating the filter coefficient, and acquisition of the low-noise signal in the step of acquiring the low-noise signal is executed by using the auxiliary signal.

### (Mode Item 8)

In the noise reduction processing method according to mode item 7, the auxiliary signal includes the low-noise signal; and processing in at least one of estimating the noise signal in the step of estimating the noise signal, calculating the similarity index in the step of calculating the similarity index, calculating the filter coefficient in the step of calculating the filter coefficient, and acquiring the low-noise signal in the step of acquiring the low-noise signal is executed by using the low-noise signal as the auxiliary signal.

### (Mode Item 9)

In the noise reduction processing method according to any of mode items 1 to 8, processing in at least one of estimating the noise signal in the step of estimating the noise signal, calculating the similarity index in the step of calculating the similarity index, calculating the filter coefficient in the step of calculating the filter coefficient, and acquiring the low-noise signal in the step of acquiring the low-noise signal is executed based on a reference dataset.

### (Mode Item 10)

In the noise reduction processing method according to any of mode items 1 to 9, a step of acquiring a low-noise composite signal by combining the target signal and the low-noise signal with weights being applied to the target signal and the low-noise signal for adjustment of noise reduction effect is further provided.

### (Mode Item 11)

A noise reduction processing apparatus for reducing noise in a target signal according to mode item 11 is an apparatus including a target signal acquirer for acquiring the target signal; and a noise reducer for reducing noise in the target signal, wherein the noise reducer is configured to acquire a low-frequency signal by applying a first filter including a first filter window to the target signal, to acquire a high-frequency signal based on the target signal and the low-frequency signal and to estimate the noise signal by applying a second filter including a second filter window independent of the first filter window to the high-frequency signal, to calculate a similarity index between a predetermined signal that is acquired at a first signal point and a signal that is acquired at a second signal point in proximity to the first signal point based on the target signal and the noise signal, to calculate a filter coefficient of a noise reduction filter based on the similarity index, and to acquire a low-noise signal by applying the noise reduction filter to the target signal based on the filter coefficient.

### (Mode Item 12)

A noise reduction processing method for reducing noise in a target signal according to mode item 12 is a noise reduction processing method including a step of estimating a noise signal representing an intensity distribution of the noise in the target signal based on the target signal; a step of calculating a similarity index between a predetermined signal that is acquired at a first signal point and a signal that is acquired at a second signal point in proximity to the first signal point based on the target signal and the noise signal; a step of calculating a filter coefficient of a noise reduction filter based on the similarity index; a step of acquiring a low-noise signal by applying the noise reduction filter to the target signal based on the filter coefficient; and a step of acquiring a low-noise composite signal by combining the target signal and the low-noise signal for adjustment of noise reduction effect.

### (Mode Item 13)

In the noise reduction processing method according to mode item 12, in the step of acquiring the low-noise composite signal, a low-noise composite signal is acquired by combining the target signal and the low-noise signal with weights being applied to the target signal and the low-noise signal.

### (Mode Item 14)

In the noise reduction processing method according to mode item 12 or 13, in the step of acquiring the low-noise composite signal, the low-noise signal is acquired by using the noise signal together with the target signal and the low-noise signal.

### (Mode Item 15)

In the noise reduction processing method according to any of mode items 12 to 14, in the step of acquiring the low-noise composite signal, the low-noise signal is acquired by using at least one of the similarity index and the filter coefficient together with the target signal and the low-noise signal.

### (Mode Item 16)

In the noise reduction processing method according to any of mode items 12 to 14, a step of acquiring an auxiliary signal of a common target whose target signal has been acquired, the auxiliary signal being acquired by an apparatus that is different from an apparatus that captures the target signal, under an acquisition condition that is different from a condition that the target signal is acquired, or under a processing condition that is different from processing condition that the target signal is acquired is further provided; and processing in at least one of estimation of the noise signal in the step of estimating the noise signal, estimation of the similarity index in the step of calculating the similarity index, calculation of the filter coefficient in the step of calculating the filter coefficient, acquisition of the low-noise signal in the step of acquiring the low-noise signal, and acquisition of the low-noise composite signal in the step of acquiring the low-noise composite signal is executed by using the auxiliary signal.

### (Mode Item 17)

In the noise reduction processing method according to any of mode items 12 to 14, processing in at least one of estimation of the noise signal in the step of estimating the noise signal, calculation of the similarity index in the step of calculating the similarity index, calculation of the filter coefficient in the step of calculating the filter coefficient, acquisition of the low-noise signal in the step of acquiring the low-noise signal, and acquisition of the low-noise composite signal in the step of acquiring the low-noise composite signal is executed based on a reference dataset.

### (Mode Item 18)

A noise reduction processing apparatus for reducing noise in a target signal according to mode item 18 is an apparatus including a target signal acquirer for acquiring the target signal; and a noise reducer for reducing noise of the target signal, wherein the noise reducer is configured to estimate a noise signal representing an intensity distribution of the noise in the target signal based on the target signal, to calculate a similarity index between a predetermined signal that is acquired at a first signal point and a signal that is acquired at a second signal point in proximity to the first signal point based on the target signal and the noise signal, to calculate a filter coefficient of a noise reduction filter based on the similarity index, to acquire a low-noise signal by applying the noise reduction filter to the target signal based on the filter coefficient, and to acquire a low-noise composite signal whose noise reduction effect is adjusted by combining the target signal and the low-noise signal for adjustment of noise reduction effect.

What is claimed is:

1. A noise reduction processing method for reducing noise in a target signal, the method comprising:
a step of estimating a noise signal representing an intensity distribution of the noise in the target signal;
a step of calculating a similarity index between a predetermined signal that is acquired at a first signal point and a signal that is acquired at a second signal point in proximity to the first signal point based on the target signal and the noise signal;
a step of calculating a filter coefficient of a noise reduction filter based on the similarity index; and
a step of acquiring a low-noise signal by applying the noise reduction filter to the target signal based on the filter coefficient, wherein
in the step of estimating the noise signal,
a low-frequency signal is acquired by applying a first filter including a first filter window to the target signal,
a high-frequency signal is acquired based on the target signal and the low-frequency signal, and
the noise signal is estimated by applying a second filter including a second filter window independent of the first filter window to the high-frequency signal.

2. The noise reduction processing method according to claim 1, wherein
the first filter includes a smoothing filter;
the second filter includes a standard deviation filter; and
in the step of estimating the noise signal, the noise signal is estimated by applying the standard deviation filter, which is different from the smoothing filter, to the high-frequency signal.

3. The noise reduction processing method according to claim 2, wherein
the target signal is a two- or higher-dimensional image signal;
the noise reduction processing method further comprises acquiring, based on a noise distribution of one of noise caused by an acquisition principle in acquisition of the image signal and noise caused by an apparatus that acquires the image signal, a noise model of the noise distribution; and
in the step of estimating the noise signal, the noise signal is estimated by multiplying the high-frequency signal by the noise model following to the applying the second filter to the high-frequency signal.

4. The noise reduction processing method according to claim 3, wherein a series of processing including the step of estimating the noise signal, the step of calculating the similarity index, the step of calculating the filter coefficient and the step of acquiring the low-noise signal is repeatedly executed by using the low-noise signal as the target signal.

5. The noise reduction processing method according to claim 1, wherein
in the step of acquiring the low-noise signal, the low-noise signal is acquired by using the noise signal together with the filter coefficient.

6. The noise reduction processing method according to claim 1, wherein in the step of calculating the filter coefficient, the filter coefficient is calculated by using the target signal together with the similarity index.

7. The noise reduction processing method according to claim 1 further comprising
a step of acquiring an auxiliary signal of a common target whose target signal has been acquired, the auxiliary signal being acquired by an apparatus that is different from an apparatus that captures the target signal, under an acquisition condition that is different from a condition that the target signal is acquired, or under a processing condition that is different from processing condition that the target signal is acquired, wherein
processing in at least one of estimation of the noise signal in the step of estimating the noise signal, calculation of the similarity index in the step of calculating the similarity index, calculation of the filter coefficient in the step of calculating the filter coefficient, and acquisition of the low-noise signal in the step of acquiring the low-noise signal is executed by using the auxiliary signal.

8. The noise reduction processing method according to claim 7, wherein
the auxiliary signal includes the low-noise signal; and
processing in at least one of estimating the noise signal in the step of estimating the noise signal, calculating the similarity index in the step of calculating the similarity index, calculating the filter coefficient in the step of calculating the filter coefficient, and acquiring the low-noise signal in the step of acquiring the low-noise signal is executed by using the low-noise signal as the auxiliary signal.

9. The noise reduction processing method according to claim 1, wherein processing in at least one of estimating the noise signal in the step of estimating the noise signal, calculating the similarity index in the step of calculating the similarity index, calculating the filter coefficient in the step of calculating the filter coefficient, and acquiring the low-noise signal in the step of acquiring the low-noise signal is executed based on a reference dataset.

10. The noise reduction processing method according to claim 1 further comprising a step of acquiring a low-noise composite signal by combining the target signal and the low-noise signal with weights being applied to the target signal and the low-noise signal for adjustment of noise reduction effect.

11. A noise reduction processing apparatus for reducing noise in a target signal, the apparatus including
a target signal acquirer for acquiring the target signal; and
a noise reducer for reducing noise in the target signal, wherein
the noise reducer is configured
to acquire a low-frequency signal by applying a first filter including a first filter window to the target signal, to acquire a high-frequency signal based on the target signal and the low-frequency signal and to estimate the noise signal by applying a second filter including a second filter window independent of the first filter window to the high-frequency signal,
to calculate a similarity index between a predetermined signal that is acquired at a first signal point and a signal that is acquired at a second signal point in proximity to the first signal point based on the target signal and the noise signal,
to calculate a filter coefficient of a noise reduction filter based on the similarity index, and
to acquire a low-noise signal by applying the noise reduction filter to the target signal based on the filter coefficient.

12. A noise reduction processing method for reducing noise in a target signal, the method comprising:
a step of estimating a noise signal representing an intensity distribution of the noise in the target signal based on the target signal;
a step of calculating a similarity index between a predetermined signal that is acquired at a first signal point and a signal that is acquired at a second signal point in proximity to the first signal point based on the target signal and the noise signal;
a step of calculating a filter coefficient of a noise reduction filter based on the similarity index;
a step of acquiring a low-noise signal by applying the noise reduction filter to the target signal based on the filter coefficient; and
a step of acquiring a low-noise composite signal by combining the target signal and the low-noise signal for adjustment of noise reduction effect.

13. The noise reduction processing method according to claim 12, wherein in the step of acquiring the low-noise composite signal, a low-noise composite signal is acquired by combining the target signal and the low-noise signal with weights being applied to the target signal and the low-noise signal.

14. The noise reduction processing method according to claim 12, wherein in the step of acquiring the low-noise composite signal, the low-noise signal is acquired by using the noise signal together with the target signal and the low-noise signal.

15. The noise reduction processing method according to claim 12, wherein in the step of acquiring the low-noise composite signal, the low-noise signal is acquired by using at least one of the similarity index and the filter coefficient together with the target signal and the low-noise signal.

16. The noise reduction processing method according to claim 12 further comprising a step of acquiring an auxiliary signal of a common target whose target signal has been acquired, the auxiliary signal being acquired by an apparatus that is different from an apparatus that captures the target signal, under an acquisition condition that is different from a condition that the target signal is acquired, or under a processing condition that is different from processing condition that the target signal is acquired, wherein
processing in at least one of estimation of the noise signal in the step of estimating the noise signal, estimation of the similarity index in the step of calculating the similarity index, calculation of the filter coefficient in the step of calculating the filter coefficient, acquisition of the low-noise signal in the step of acquiring the low-noise signal, and acquisition of the low-noise composite signal in the step of acquiring the low-noise composite signal is executed by using the auxiliary signal.

17. The noise reduction processing method according to claim 12, wherein processing in at least one of estimation of the noise signal in the step of estimating the noise signal, calculation of the similarity index in the step of calculating the similarity index, calculation of the filter coefficient in the step of calculating the filter coefficient, acquisition of the low-noise signal in the step of acquiring the low-noise signal, and acquisition of the low-noise composite signal in the step of acquiring the low-noise composite signal is executed based on a reference dataset.

18. The noise reduction processing apparatus according to claim 11, wherein the noise reducer is configured to acquire a low-noise composite signal by combining the target signal and the low-noise signal for adjustment of noise reduction effect.
